(19) United States
(12) Patent Application Publication
(10) Pub. No.: US 2019/0286064 A1
(43) Pub. Date: Sep. 19, 2019

(54) HAND POSITION IDENTIFICATION DEVICE, TIMEPIECE, AND HAND POSITION IDENTIFICATION METHOD

(71) Applicant: Seiko Instruments Inc., Chiba-shi (JP)

(72) Inventor: Kosuke YAMAMOTO, Chiba-shi (JP)

(21) Appl. No.: 16/298,061

(22) Filed: Mar. 11, 2019

(30) Foreign Application Priority Data
Mar. 13, 2018 (JP) 2018-045915
Dec. 19, 2018 (JP) 2018-237614

(51) Int. Cl. G04C 3/16; G04C 3/10; G04C 9/08

(52) U.S. Cl. CPC G04C 3/165; G04C 9/08; G04C 3/107; G04C 3/108

(57) ABSTRACT

A hand position identification device includes a rotation detection unit that detects a rotation state of a rotor by using an induced voltage generated in a motor for rotating a hand, a storage unit that stores a timing information piece relating to a timing at which the induced voltage exceeds a predetermined threshold, and a control unit that compares a first timing information piece stored in the storage unit and obtained in a case where the hand is located at a first position, with a second timing information piece obtained in a case where the hand is located at a second position, and that identifies the second position as an identified position in a case where a difference between the first timing information piece and the second timing information piece is equal to or more than a predetermined amount.

### RELATED APPLICATIONS

This application claims priority under 35 U.S.C. §119 to Japanese Patent Application Nos. 2018-045915 filed Mar. 13, 2018 and 2018-237614 filed Dec. 19, 2018, the entire content of which are hereby incorporated by reference.

### BACKGROUND OF THE INVENTION

### 1. Field of the Invention

The present disclosure relates to a hand position identification device, a timepiece, and a hand position identification method.

### 2. Description of the Related Art

In a timepiece, as a method of detecting a position of an indicating hand, for example, the following method is known. A hole belonging to a gear configuring a train wheel is interposed between a light emitting element and a light receiving element so as to be detected depending on whether transmitted light is present or absent. However, according to the method, it is necessary to arrange the light emitting element and the light receiving element, thereby causing a problem in that a whole size of the timepiece inevitably increases. As means for coping with the problem, a rotation state detection technique has been proposed in which the indicating hand of the timepiece is driven using a drive pulse during normal driving so as to detect a rotation state thereof by using an induced voltage (for example, refer to Japanese Patent No. 5363167).

Furthermore, according to a technique disclosed in Japanese Patent No. 3625395, in order to detect a predetermined position of the indicating hand, a high load is applied to the train wheel so that a motor is not rotated at a position corresponding to the predetermined position. Then, according to the technique disclosed in Japanese Patent No. 3625395, the predetermined position is determined as follows. At the predetermined position of the high load, the motor cannot be rotated using a normal drive pulse during the normal driving for time display, and the motor can be rotated in a case where the motor is driven using a correction drive pulse having greater drive energy than that during the normal driving. According to the technique disclosed in Japanese Patent No. 3625395, whether or not the motor is rotated is determined, based on the induced voltage generated in the motor.

### SUMMARY OF THE INVENTION

However, according to the related art disclosed in Japanese Patent No. 5363167 or Japanese Patent No. 3625395, unless a load is installed to such an extent that the correction drive pulse is output in a case where it is detected that the motor is not in a rotated state, it is difficult to determine the predetermined position. Furthermore, in order to install the load to such an extent that the correction drive pulse is required, the motor needs to be driven using the correction drive pulse in addition to the normal drive pulse. Consequently, the driving of the motor is hindered in some cases. Even in a case of using the correction drive pulse, there is a possibility that not only power consumption required for driving the motor may increase but also the load further may increase due to aged deterioration. Therefore, the motor cannot be driven even using the correction drive pulse in some cases.

Each of embodiments of the present invention is made in view of the above-described problem, and provides a hand position identification device, a timepiece, and a hand position identification method, which can identify a hand position corresponding to a load position even though a slight load is applied to the load position to such an extent that a correction drive pulse is not used.

According to an embodiment of the present invention, in order to achieve the above-described object, a hand position identification device includes a rotation detection unit that detects a rotation state of a rotor by using an induced voltage generated in a coil of a motor for rotating an indicating hand after a drive pulse is output to the coil, a storage unit that stores a timing information piece relating to a timing at which the induced voltage exceeds a predetermined threshold, and a control unit that compares a first timing information piece stored in the storage unit, which is a timing information piece obtained in a case where the indicating hand is located at a first indicating hand position, with a second timing information piece which is a timing information piece obtained in a case where the indicating hand is located at a second indicating hand position, and that identifies the second indicating hand position as an identified position in a case where a difference between the first timing information piece and the second timing information piece is equal to or more than a predetermined amount.

In the hand position identification device according to the embodiment of the present invention, the predetermined amount may be equivalent to two search pulses output during a period while the rotation detection unit detects the rotation state of the rotor.

In the hand position identification device according to the embodiment of the present invention, the storage unit may store the timing information piece for each polarity of the rotor. The control unit may compare the first timing information piece obtained in a case where the indicating hand is located at the first indicating hand position and in a case where the rotor has a first polarity, with the second timing information piece obtained in a case where the indicating hand is located at the second indicating hand position and in a case where the rotor has the first polarity, and the control unit may identify the second indicating hand position as the identified position in a case where a difference between the first timing information piece and the second timing information piece is equal to or more than the predetermined amount.

In the hand position identification device according to the embodiment of the present invention, the storage unit may store a plurality of the timing information pieces in a case where a plurality of the timing information pieces are present at one indicating hand position. In a case where a plurality of the second timing information pieces are present, the control unit may select the second timing information piece closer to the first timing information piece out of a plurality of the second timing information pieces, compares the first timing information piece with the selected second timing information piece, may identify the second indicating hand position as the identified position in a case where a difference between the first timing information piece and the second timing information piece is equal to or more than the predetermined amount, or in a case where a plurality of the first timing information pieces are present, the control unit selects the first timing information piece closer to the second timing information piece out of a plurality of the first timing information pieces, may compare the selected first timing information piece with the second timing information piece, and may identify the second indicating hand position as the identified position in a case where a difference between the first timing information piece and the second timing information piece is equal to or more than the predetermined amount.

In the hand position identification device according to the embodiment of the present invention, the timing information piece may indicate what number-th is the induced voltage, with reference to a timing after the drive pulse is output.

In the hand position identification device according to the embodiment of the present invention, the timing information piece may indicate an elapsed time until the induced voltage is generated, with reference to a timing after the drive pulse is output.

In the hand position identification device according to the embodiment of the present invention, in a case where the induced voltage exceeding the predetermined threshold is not detected by the rotation detection unit, the control unit may increase drive energy of the drive pulse until the induced voltage is equal to or smaller than the predetermined threshold in a first region where the indicating hand is located at a reference position and until a load received by the rotor exceeds the induced voltage in a second region in which the load is lower than that of the first region.

In the hand position identification device according to the embodiment of the present invention, the rotation detection unit may generate another predetermined threshold which is smaller than the predetermined threshold in a case where the induced voltage exceeding the predetermined threshold is not detected. The storage unit may store the timing information piece relating to a timing at which the induced voltage exceeds another predetermined threshold.

In the hand position identification device according to the embodiment of the present invention, the rotation detection unit may alternately switch a circuit including the coil into a high impedance state and a low impedance state which is lower than the high impedance state so as to detect the induced voltage in the low impedance state. In a case where the induced voltage exceeding the predetermined threshold is not detected, the rotation detection unit may shorten a cycle for alternately switching the low impedance state and the high impedance state until the induced voltage exceeding the predetermined threshold is detected.

According to an embodiment of the present invention, in order to achieve the above-described object, a timepiece includes any one of the above-described hand position identification devices.

According to an embodiment of the present invention, in order to achieve the above-described object, there is provided a hand position identification method in a hand position identification device including a motor having a rotor and a coil, an indicating hand rotated by the motor, a rotation detection unit for detecting a rotation state of the rotor by using an induced voltage generated in the coil, and a storage unit. The hand position identification method includes a step of causing the rotation detection unit to detect the rotation state of the rotor by using the induced voltage generated in the coil after a drive pulse is output to the coil, a step of causing the control unit to store a timing information piece relating to a timing at which the induced voltage exceeds a predetermined threshold, in a storage unit, and a step of causing the control unit to compare a first timing information piece stored in the storage unit, which is a timing information piece obtained in a case where the indicating hand is located at a first indicating hand position, with a second timing information piece which is a timing information piece obtained in a case where the indicating hand is located at a second indicating hand position, and causing the control unit to identify the second indicating hand position as an identified position in a case where a difference between the first timing information piece and the second timing information piece is equal to or more than a predetermined amount.

### BRIEF DESCRIPTION OF THE DRAWINGS

FIG. 1 is a block diagram illustrating a configuration example of a timepiece according to a first embodiment.

FIG. 2 is a view for describing an example of a reference load unit and a reference position according to the first embodiment.

FIG. 3 is a view illustrating a configuration example of a motor according to the first embodiment.

FIG. 4 is a block diagram illustrating each configuration example of an indicating hand drive unit and a rotation detection unit according to the first embodiment.

FIG. 5 is a view illustrating an example of a drive pulse output by a pulse control unit according to the first embodiment.

FIG. 6 is a view illustrating an example of a main drive pulse and a detection period according to the first embodiment.

FIG. 7 is a view illustrating an example of the main drive pulse and an induced voltage according to the first embodiment.

FIG. 8 is a view illustrating an example of a state, a rotation behavior of a rotor, an induced voltage waveform, and an induced voltage timing according to the first embodiment.

FIG. 9 is a view for describing a method of detecting a reference position according to the first embodiment.

FIG. 10 is a view illustrating an information example stored in a storage unit according to the first embodiment.

FIG. 11 is a flowchart illustrating a procedure example of detecting the reference position according to the first embodiment.

FIG. 12 is a block diagram illustrating a configuration example of a timepiece according to a second embodiment.

FIG. 13 is a view illustrating an information example stored in a storage unit according to the second embodiment.

FIG. 14 is a flowchart illustrating a procedure example of detecting a reference position according to the second embodiment.

FIG. 15 is a view illustrating an example of a timing information piece according to a third embodiment.

FIG. 16 is a flowchart illustrating a procedure example of detecting a reference position according to the third embodiment.

FIG. 17 is a view illustrating an example of a main drive pulse and a detection period according to a fourth embodiment.

FIG. 18 is a view illustrating an example of the main drive pulse and an induced voltage according to the fourth embodiment.

### DETAILED DESCRIPTION OF THE PREFERRED EMBODIMENTS

Hereinafter, embodiments according to the present invention will be described with reference to the drawings. In the drawings used in the following description, a scale of each member is appropriately changed in order to enable each member to have a recognizable size.

### First Embodiment

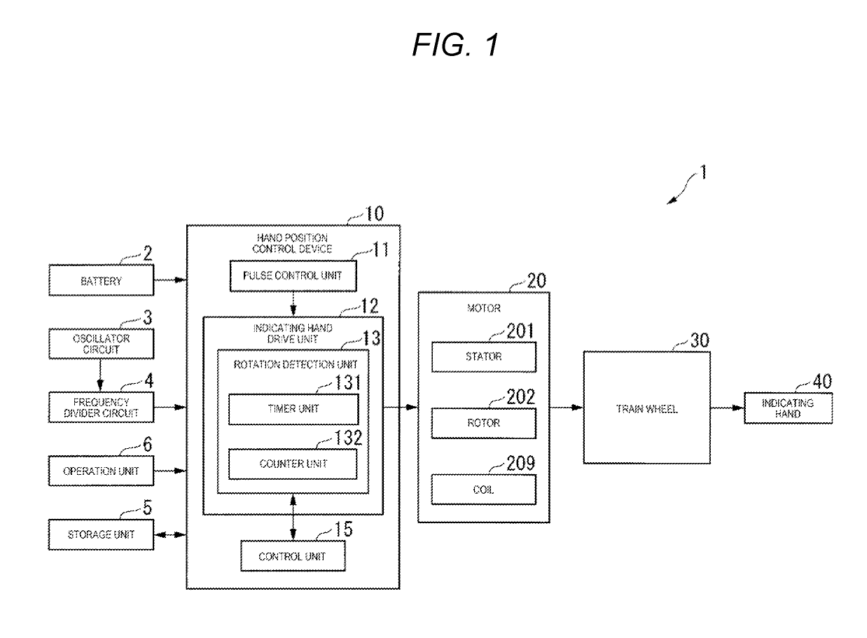

FIG. 1 is a block diagram illustrating a configuration example of a timepiece 1 according to the present embodiment. As illustrated in FIG. 1, the timepiece 1 includes a battery 2, an oscillator circuit 3, a frequency divider circuit 4, a storage unit 5, an operation unit 6, a hand position control device 10 (hand position identification device), a motor 20, a train wheel 30, and an indicating hand 40.

The hand position control device 10 includes a pulse control unit 11, an indicating hand drive unit 12, and a control unit 15. The indicating hand drive unit 12 includes a rotation detection unit 13. The rotation detection unit 13 includes a timer unit 131 and a counter unit 132.

The timepiece 1 illustrated in FIG. 1 is an analog timepiece which displays a measured time by using the indicating hand 40. In the example illustrated in FIG. 1, for the sake of simple description, the timepiece 1 includes one indicating hand 40. However, the number of the indicating hands 40 may be two or more. In that case, the timepiece 1 includes the indicating hand drive unit 12, the motor 20, and the train wheel 30 for each indicating hand 40.

For example, the battery 2 is a lithium battery or a silver oxide battery, which is a so-called button battery. The battery 2 may be a solar cell or a storage battery which stores electric power generated by the solar cell. The battery 2 supplies the electric power to the hand position control device 10.

For example, the oscillator circuit 3 is a passive element used to oscillate a predetermined frequency from mechanical resonance thereof by utilizing a piezoelectric phenomenon of quartz. Here, the predetermined frequency is 32 kHz, for example.

The frequency divider circuit 4 divides a signal having the predetermined frequency output by the oscillator circuit 3 into a desired frequency, and outputs the frequency divided signal to the hand position control device 10.

The storage unit 5 stores a main drive pulse and a correction drive pulse. The storage unit 5 stores a mask time and a timing information piece. The main drive pulse, the correction drive pulse, the mask time, and the timing information piece will be described later. Each time the indicating hand 40 is rotated, the storage unit 5 stores the timing information piece indicating what number-th is the induced voltage exceeding a threshold voltage (predetermined threshold) after the main drive pulse is applied, when a reference position is detected. The reference position, the induced voltage, and the threshold voltage will be described later. The information stored in the storage unit 5 will be described later.

During normal driving, the hand position control device 10 operates the indicating hand 40 via the train wheel 30 by driving the motor 20. The hand position control device 10 detects the reference position, based on the induced voltage generated in the motor 20 after the main drive pulse is output, when the reference position is detected.

The pulse control unit 11 measures the time by using the desired frequency divided by the frequency divider circuit 4, generates a pulse signal so as to operate the indicating hand 40 in accordance with a result obtained by measuring the time, and outputs the generated pulse signal to the indicating hand drive unit 12.

In accordance with the control of the pulse control unit 11, the indicating hand drive unit 12 generates the pulse signal for rotating the motor 20 forward or rearward. The indicating hand drive unit 12 drives the motor 20 by using the generated pulse signal (drive pulse). The timer unit 131 counts the mask time after the main drive pulse is applied to the motor 20 by the indicating hand drive unit 12, when the reference position is detected. The indicating hand drive unit 12 detects the induced voltage generated in a coil 209 by rotating the motor 20 when the reference position is detected, causes the counter unit 132 to count what number-th is the induced voltage exceeding the threshold voltage, and outputs the timing information piece obtained by counting the number to the control unit 15.

The timer unit 131 counts the mask time by using the desired frequency generated in the frequency divider circuit 4, when the reference position is detected.

The counter unit 132 counts what number-th is the induced voltage exceeding the threshold voltage out of the induced voltages generated by rotating a rotor 202 after the main drive pulse is applied, when the reference position is detected, and outputs the timing information piece obtained by counting the number to the control unit 15. A method of counting the induced voltages will be described later. The counter unit 132 counts what number-th is the induced voltage exceeding the threshold voltage, when the induced voltage exceeds the threshold voltage for the first time.

Each time the indicating hand 40 is rotated, the control unit 15 causes the storage unit 5 to store the timing information piece output by the indicating hand drive unit 12 when the reference position is detected. The control unit 15 compares two different rotation timing information pieces stored in the storage unit 5 when the reference position is detected, and detects the reference position, based on the comparison result. A method of driving the motor 20 when the reference position is detected and a method of detecting the reference position will be described later.

The motor 20 is a stepping motor, for example. The motor 20 drives the indicating hand 40 via the train wheel 30 by using the pulse signal output by the indicating hand drive unit 12.

The train wheel 30 is configured to include at least one gear. In the present embodiment, for example, a shape of the gear belonging to the train wheel 30 is processed for the train wheel 30. In this manner, the train wheel 30 is formed so that a load fluctuates at one location while the indicating hand 40 is rotated 360 degrees. That is, in the present embodiment, a configuration is adopted as follows. A reference load unit is disposed at a predetermined position in a drive mechanism including the indicating hand 40 and the rotor belonging to the motor 20. When the indicating hand 40 is located at the reference position, the load received by the rotor is caused to fluctuate.

For example, the indicating hand 40 is an hour hand, a minute hand, or a second hand. The indicating hand 40 is rotatably supported by a support body (not illustrated).

### Reference Load Unit and Reference Position

Next, the reference load unit and the reference position will be described.

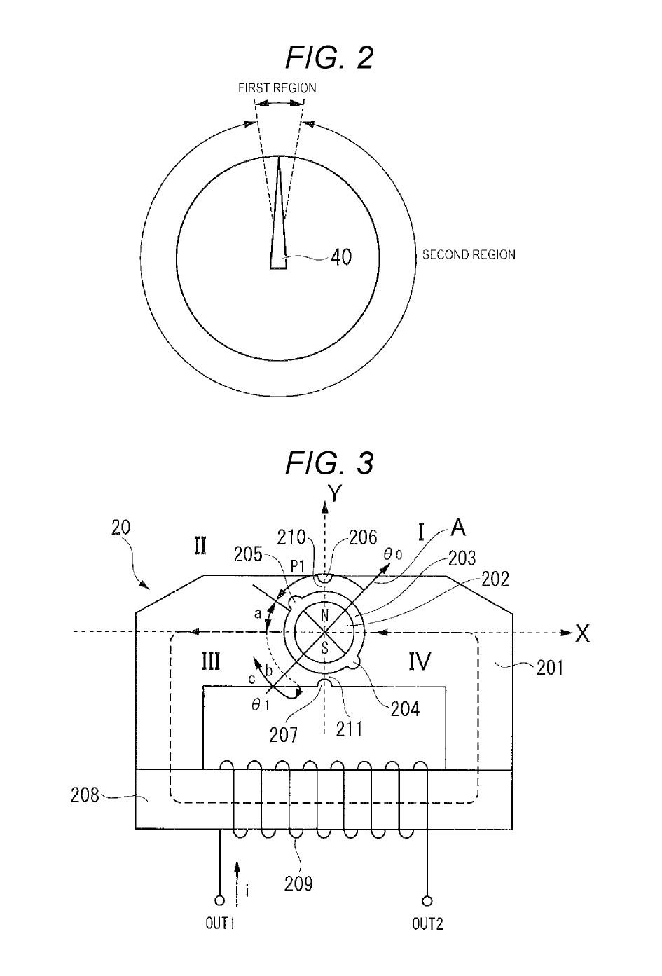

FIG. 2 is a view for describing an example of the reference load unit and the reference position according to the present embodiment.

In FIG. 2, when a position of approximately 12 o'clock is the reference position and the indicating hand is located at this position (first region), compared to the other position (second region), the load received by the rotor 202 is high. The load in the first region is a load for rotating the rotor 202 by using the main drive pulse without using the correction drive pulse. That is, in the example illustrated in FIG. 2, the reference load unit is disposed at the position of approximately 12 o'clock. In other words, the load of the first region which is received by the rotor is higher than the load of the second region. According to the present embodiment, the position where the load received by the rotor increases is detected as the reference position.

FIG. 2 illustrates an example in which the position of approximately 12 o'clock is the reference position. However, the reference position may be the other position.

### Configuration Example and Operation Example of Motor 20

Next, a configuration example and an operation example of the motor 20 will be described.

FIG. 3 is a view illustrating the configuration example of the motor 20 according to the present embodiment.

In a case where the motor 20 is used for an analog electronic timepiece, a stator 201 and a coil core 208 are fixed to a main plate (not illustrated) by using a screw (not illustrated), and are joined to each other. The coil 209 has a first terminal OUT1 and a second terminal OUT2.

The rotor 202 is magnetized in two poles (south pole and north pole). An outer end portion of the stator 201 formed of a magnetic material is provided with a plurality of (two in the present embodiment) cutout portions (outer notches) 206 and 207 at positions facing each other across a rotor accommodating through-hole 203. Saturable portions 210 and 211 are disposed between the respective outer notches 206 and 207 and the rotor accommodating through-hole 203.

The saturable portions 210 and 211 are not magnetically saturated depending on a magnetic flux of the rotor 202, and are configured so that magnetic resistance increases by being magnetically saturated when the coil 209 is excited. The rotor accommodating through-hole 203 is configured to have a circular hole shape in which a plurality of (two in the present embodiment) crescentic cutout portions (inner notches) 204 and 205 are integrally formed in facing portions of a through-hole having a circular contour.

The cutout portions 204 and 205 configure a positioning unit for determining a stop position of the rotor 202. In a state where the coil 209 is not excited, the rotor 202 is located at a position corresponding to the positioning unit as illustrated in FIG. 3. In other words, the rotor 202 is stably stopped at a position (position of an angle θ₀) where a magnetic pole axis A of the rotor 202 is perpendicular to a line segment connecting the cutout portions 204 and 205 to each other. An XY-coordinate space centered on a rotation axis (rotation center) of the rotor 202 is divided into four quadrants (first quadrant I to fourth quadrant IV).

In FIG. 3, signs a, b, and c are respectively rotation regions of the rotor 202.

Here, the main drive pulse having a rectangular wave is supplied from the indicating hand drive unit 12 to between the terminals OUT1 and OUT2 of the coil 209 (for example, the first terminal OUT1 side is set to a cathode, and the second terminal OUT2 side is set to an anode). If a drive current i flows in a direction indicated by an arrow in FIG. 3, a magnetic flux is generated in the stator 201 in a direction indicated by a broken line arrow. In this manner, the saturable portions 210 and 211 are saturated, and the magnetic resistance of the resistor increases. Thereafter, due to interaction between the magnetic pole generated in the stator 201 and the magnetic pole of the rotor 202, the rotor 202 is rotated 180 degrees in the direction indicated by the arrow in FIG. 3, and is stably stopped at a position where the magnetic pole axis shows an angle θ₁. A rotation direction (counterclockwise direction in FIG. 3) for allowing a normal operation (indicating hand operation since the present embodiment employs the analog electronic timepiece) to be performed by rotationally driving a stepping motor 107 will be referred to as a forward direction, and a direction opposite thereto (clockwise direction) will be referred to as the rearward direction.

If the drive current I flows in a direction opposite to the arrow in FIG. 3 by supplying the main drive pulse having the rectangular wave of the opposite polarity from the indicating hand drive unit 12 to the terminals OUT1 and OUT2 of the coil 209 (the first terminal OUT1 side is set to the anode, and the second terminal OUT2 side is set to the cathode so as to have the opposite polarity compared to the precedent driving), the magnetic flux is generated in the stator 201 in the direction opposite to the broken arrow. In this manner, the saturable portions 210 and 211 are first saturated. Thereafter, due to the interaction between the magnetic pole generated in the stator 201 and the magnetic pole of the rotor 202, the rotor 202 is rotated 180 degrees in the same direction (forward direction), and is stably stopped at a position where the magnetic pole axis shows the angle θ₀.

Thereafter, in this way, the indicating hand drive unit 12 supplies a signal (alternating signal) having different polarity to the coil 209. In this manner, the motor 20 repeatedly performs the operation. A configuration is adopted in which the rotor 202 can be continuously rotated every 180 degrees in the direction of the arrow.

The indicating hand drive unit 12 (FIG. 1) rotationally drives the motor 20 by alternately driving the motor 20 by using a drive pulse P1 having mutually different polarities. In a case where the motor 20 cannot be rotated using a main drive pulse P1, the motor 20 is rotationally driven using a correction drive pulse P2 having the polarity the same as the polarity of the main drive pulse P1.

### Configuration Example of Indicating Hand Drive Unit 12 and Rotation Detection Unit 13

Next, a configuration example of the indicating hand drive unit 12 and the rotation detection unit 13 will be described.

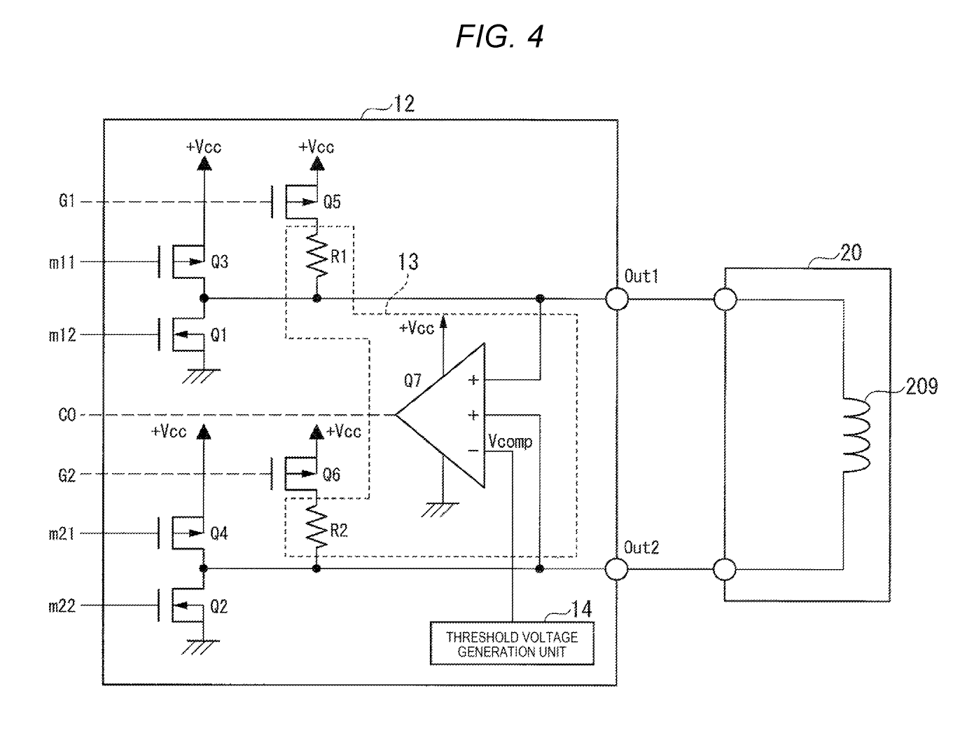

FIG. 4 is a block diagram illustrating the configuration example of the indicating hand drive unit 12 and the rotation detection unit 13 according to the present embodiment. The configuration of the indicating hand drive unit 12 and the rotation detection unit 13 illustrated in FIG. 4 is an example, and the invention is not limited thereto.

As illustrated in FIG. 4, the indicating hand drive unit 12 includes switching elements Q1 to Q6, the rotation detection unit 13, and a threshold voltage generation unit 14.

The rotation detection unit 13 includes resistors R1 and R2 and a comparator Q7.

In the switching element Q3, a gate is connected to a drive terminal for outputting a control signal m11 of the pulse control unit 11, a source is connected to a power source +Vcc, and a drain is connected to a drain of the switching element Q1, one end of the resistor R1, a first input portion (+) of the comparator Q7, and a first output terminal Out1.

In the switching element Q1, a gate is connected to a drive terminal for outputting a control signal m12 of the pulse control unit 11, and a source is grounded.

In the switching element Q5, a gate is connected to a control terminal for outputting a control signal G1 of the pulse control unit 11, a source is connected to the power source +Vcc, and a drain is connected to the other end of the resistor R1.

In the switching element Q4, a gate is connected to a drive terminal for outputting a control signal m21 of the pulse control unit 11, a source is connected to the power source +Vcc, and a drain is connected to a drain of the switching element Q2, one end of the resistor R2, a second input portion (+) of the comparator Q7, and a second output terminal Out2.

In the switching element Q2, a gate is connected to a drive terminal for outputting a control signal m22 of the pulse control unit 11, and a source is grounded.

In the switching element Q6, a gate is connected to a control terminal for outputting a control signal G2 of the pulse control unit 11, a source is connected to the power source +Vcc, and a drain is connected to the other end of the resistor R2.

In the comparator Q7, the threshold voltage generation unit 14 is connected to a third input portion (−), and an output portion is connected to a detection terminal to which a detection signal CO of the pulse control unit 11 is input.

The motor 20 is connected to both ends of the first output terminal Out1 and the second output terminal Out2 of the indicating hand drive unit 12.

For example, each of the switching elements Q3, Q4, Q5, and Q6 is a P-channel field effect transistor (FET). For example, each of the switching elements Q1 and Q2 is an N-channel FET.

The switching elements Q1 and Q2 are configuration elements for driving the motor 20. The switching element Q5 and Q6, and the resistor R1 and the resistor R2 are configuration elements for detecting the rotation. The switching element Q3 and Q4 are configuration elements used for both driving the motor 20 and detecting the rotation of the motor 20. The switching elements Q1 to Q6 are respectively low impedance elements having low ON-resistance in an ON-state. Resistance values of the resistors R1 and R2 are the same as each other, and are greater than a value of the ON-resistance of the switching element.

The indicating hand drive unit 12 brings the switching elements Q1 and Q4 into an ON-state at the same time, and brings the switching elements Q2 and Q3 into an OFF-state at the same time. In this manner, the indicating hand drive unit 12 supplies an electric current flowing in a forward direction to the coil 209 included in the motor 20, thereby rotationally driving the motor 20 by 180 degrees in the forward direction. The indicating hand drive unit 12 brings the switching elements Q2 and Q3 into the ON-state at the same time, and brings the switching elements Q1 and Q4 into the OFF-state at the same time. In this manner, the indicating hand drive unit 12 supplies the electric current flowing in a rearward direction to the coil 209, thereby rotationally driving the motor 20 by further 180 degrees in the forward direction.

For example, the threshold voltage generation unit 14 divides a power source voltage Vcc with the resistor so as to generate a threshold voltage Vcomp.

### Example of Drive Signal Output by Pulse Control Unit 11

Next, an example of the drive signal output by the pulse control unit 11 will be described.

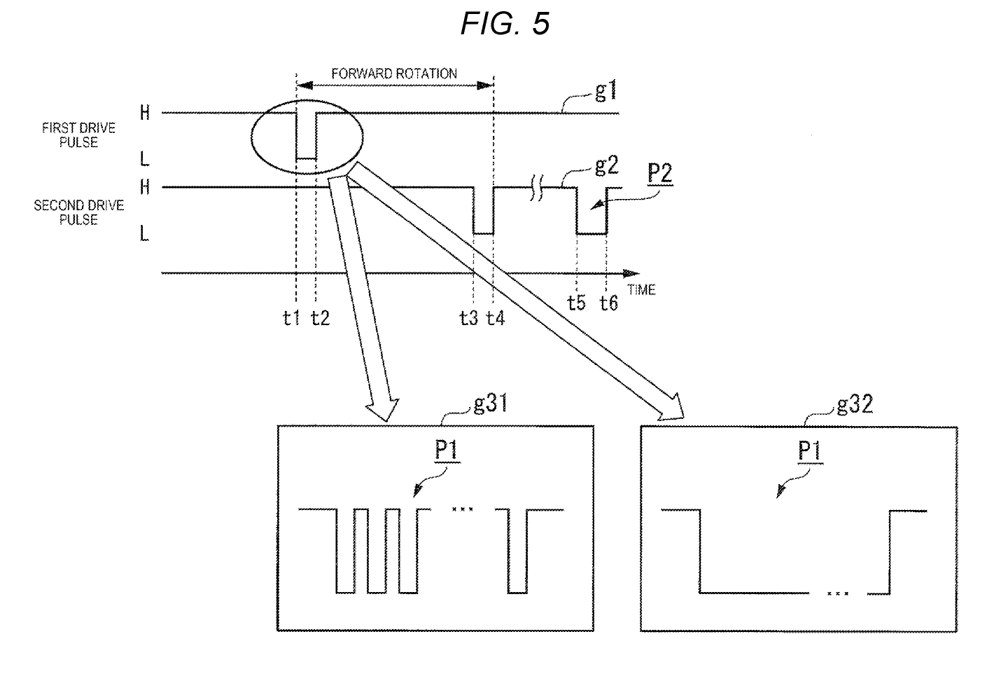

FIG. 5 is a view illustrating the example of the drive pulse output by the pulse control unit 11 according to the present embodiment.

In FIG. 5, a horizontal axis represents a time, and a vertical axis represents whether the signal is in an H (high) level or in an L (low) level. A waveform g1 is a waveform of a first drive pulse. A waveform g2 is a waveform of a second drive pulse.

During a period of times t1 to t6, the motor 20 is rotated forward. During a period of times t1 to t2, the pulse control unit 11 generates a first drive pulse m1. During a period of times t3 to t4, the pulse control unit 11 generates a second drive pulse m2. The drive signal generated during the period of times t1 to t2 or the period of times t3 to t4 is configured to include a plurality of pulse signals as in a region indicated by a sign g31, and the pulse control unit 11 adjusts a pulse duty. In this case, the period of times t1 to t2 or the period of times t3 to t4 is changed in accordance with the pulse duty. Hereinafter, in the present embodiment, a signal wave of the region indicated by the sign g31 will be referred to as a “comb tooth wave”. The drive signal generated during the period of times t1 to t2 or the period of times t3 to t4 is configured to include one pulse signal as in the region indicated by a sign g32, and the pulse control unit 11 adjusts a pulse width. In this case, the period of times t1 to t2 or the period of times t3 to t4 is changed in accordance with the pulse width. Hereinafter, in the present embodiment, a signal wave of the region indicated by the sign g32 will be referred to as a “rectangular wave”.

In the present embodiment, a pulse generated during the period of times t1 to t2 or the period of times t3 to t4 will be referred to as a main drive pulse P1. In the following description, as illustrated by the sign g31, an example will be described in which the main drive pulse P1 is the comb tooth wave.

A correction drive pulse P2 generated during a period of times t5 to t6 is a drive pulse to be output only when it is detected that the rotor 202 is not rotated by the main drive pulse P1.

In the present embodiment, when the reference position is detected, drive energy of the main drive pulse P1 is changed from strong one to weak one, for example. For example, the drive energy of the main drive pulse whose rank n is 2 is stronger than the drive energy of the main drive pulse whose rank n is 3. Here, the pulse control unit 11 changes the drive energy by changing a length of the time for outputting the pulse having the comb tooth wave, the duty of H-level and L-level of the pulse, and a voltage value of the pulse.

Next, an operation of the switching elements Q1 to Q6 when the motor 20 is driven and an example of the induced voltage generated when the motor is rotated will be described. In the following example, a case where the motor 20 is rotated forward will be described.

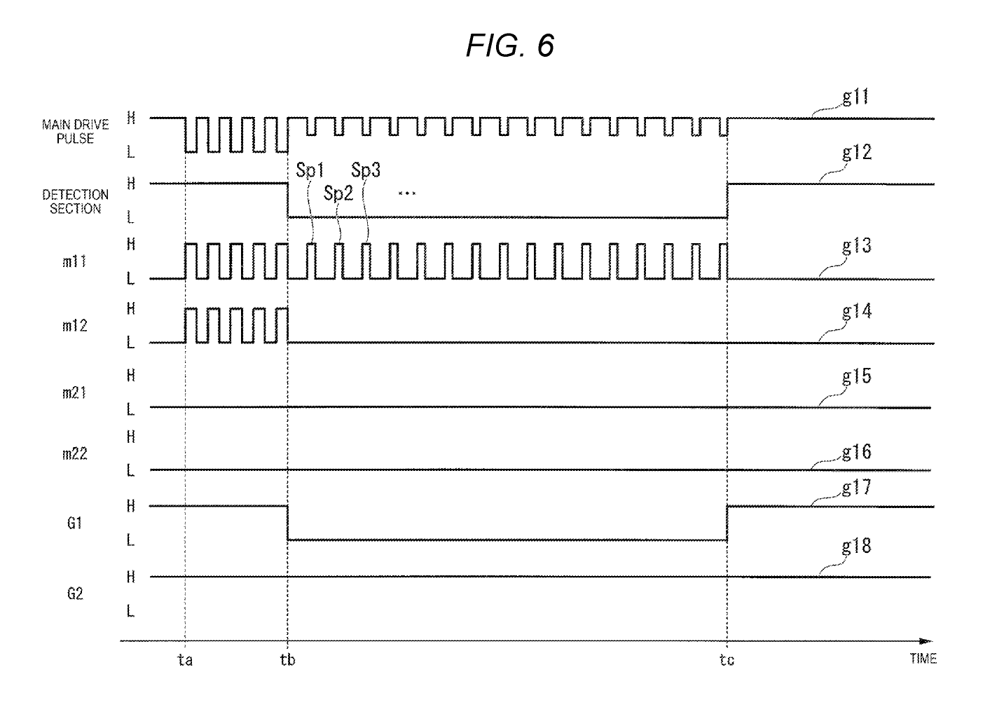

FIG. 6 is a view illustrating an example of the main drive pulse P1 and the detection period according to the present embodiment. In FIG. 6, the horizontal axis represents a time, and the vertical axis represents whether the signal is in an H-level or in an L-level. A waveform g11 is a waveform of the main drive pulse P1 and the detection pulse which are output from the first output terminal Out1 of the indicating hand drive unit 12. A sign g12 indicates a detection period. A waveform g13 is a waveform of a control signal m11 input to the gate of the switching element Q3. A waveform g14 is a waveform of a control signal m12 input to the gate of the switching element Q1. A waveform g15 is a waveform of a control signal m21 input to the gate of the switching element Q4. A waveform g16 is a waveform of a control signal m22 input to the gate of the switching element Q2. A waveform g17 is a waveform of a control signal G1 input to the gate of the switching element Q5. A waveform g18 is a waveform of a control signal G2 input to the gate of the switching element Q6.

A state illustrated in FIG. 6 represents a state during the period of times t1 to t3 in FIG. 5.

In FIG. 6, in the switching elements Q3, Q4, Q5, and Q6 (FIG. 4), the signal input to the gate is in the ON-state during the period of the L-level, and the signal input to the gate is in the OFF-state during period of the H-level. In the switching elements Q1 and Q2, the signal input to the gate is the ON-state during period of the H-level, and the signal input to the gate is in the OFF-state during the period of the L-level.

A period of times ta to tb represents a drive period.

A period of times tb to tc represents a detection period in a rotation state. Pulses Sp1, Sp2, Sp3, and so forth in the detection period are search pulses which generate the induced voltage in the coil 209 in order to detect the rotation state of the motor 20.

During the period of times ta to tb representing the drive period, as illustrated by the waveform g13 and the waveform g14, the pulse control unit 11 switches the switching elements Q3 and Q1 between the ON-state and the OFF-state at a predetermined cycle in response to the main drive pulse P1 having the comb tooth wave. In this manner, the pulse control unit 11 controls the motor 20 to be rotated in the forward direction. In a case where the motor 20 is normally rotated, the rotor 202 included in the motor 20 is rotated 180 degrees in the forward direction. During this period, the switching element Q2, Q5, and Q6 are respectively in the OFF-state, and the switching element Q4 is in the ON-state.

During the period of times tb to tc representing the detection period, the pulse control unit 11 maintains the OFF-state of the switching element Q1, switches the switching element Q3 between the ON-state and the OFF-state at a predetermined timing, and controls the switching element Q3 to be in a high-impedance state. During the detection period, the pulse control unit 11 controls the switching element Q5 to be switched to the ON-state. During the detection period, the pulse control unit 11 maintains the on-state of the switching element Q4, and controls the switching elements Q2 and Q6 to be switched to the OFF-state.

In this manner, during the detection period, a detection loop in the high impedance state where the switching elements Q4 and Q5 are in the ON-state and the switching element Q3 is in the OFF-state, and a closed loop in the low impedance state lower than the high impedance state, where the switching elements Q4 and Q5 are in the ON-state and the switching element Q3 is in the ON-state are alternately repeated at a predetermined cycle. In this case, in a state of the detection loop, the loop is configured to include the switching elements Q4 and Q5 and the resistor R1. Accordingly, the motor 20 is not braked. On the other hand, in a state of the closed loop, the loop is configured to include the switching elements Q3 and Q4 and the coil 209 belonging to the motor 20. Accordingly, the coil 209 is short-circuited. Therefore, the motor 20 is braked, and free vibration of the motor 20 is suppressed.

During the detection period after the first drive pulse is applied, the induced current flows in the resistor R1 in the direction which is the same as the flowing direction of the drive current. As a result, an induced voltage VRs (hereinafter, referred to as an induced voltage VRs) is generated in the resistor R1. The comparator Q7 compares the induced voltage VRs and a threshold voltage Vcomp with each other. In a case where the induced voltage VRs is equal to or smaller than the threshold voltage Vcomp, the comparator Q7 outputs a signal indicating “1”. In a case where the induced voltage VRs is greater than the threshold voltage Vcomp, the comparator Q7 outputs a signal indicating “0”.

Furthermore, during the period of times t3 to t5 in FIG. 5, a second drive pulse is generated. In this manner, during the drive period, the pulse control unit 11 switches the switching elements Q4 and Q2 between the ON-state and the OFF-state at a predetermined cycle in response to the main drive pulse P1. In this manner, the pulse control unit 11 controls the motor 20 to be rotated in the forward direction. During this period, the switching elements Q1, Q5, and Q6 are respectively in the OFF-state, and the switching element Q3 is in the ON-state.

During the detection period after the second drive pulse is applied, the pulse control unit 11 maintains the OFF-state of the switching element Q2, switches the switching element Q4 between the ON-state and the OFF-state at a predetermined timing, and controls the switching element Q4 to be in a high-impedance state. During the detection period, the pulse control unit 11 controls the switching element Q6 to be switched to the ON-state.

During the detection period, the pulse control unit 11 maintains the ON-state of the switching element Q3, and controls the switching elements Q1 and Q5 to be in the OFF-state. In this manner, the induced current flows in the resistor R2 in the direction which is the same as the flowing direction of the drive current. As a result, the induced voltage VRs is generated in the resistor R2. The comparator Q7 compares the induced voltage VRs and the threshold voltage Vcomp with each other. In a case where the induced voltage VRs is equal to or smaller than the threshold voltage Vcomp, the comparator Q7 outputs the signal indicating “1”. In a case where the induced voltage VRs is greater than the threshold voltage Vcomp, the comparator Q7 outputs the signal indicating “0”.

### Example of Main Drive Pulse and Induced Voltage

Next, the main drive pulse and the induced voltage will be described.

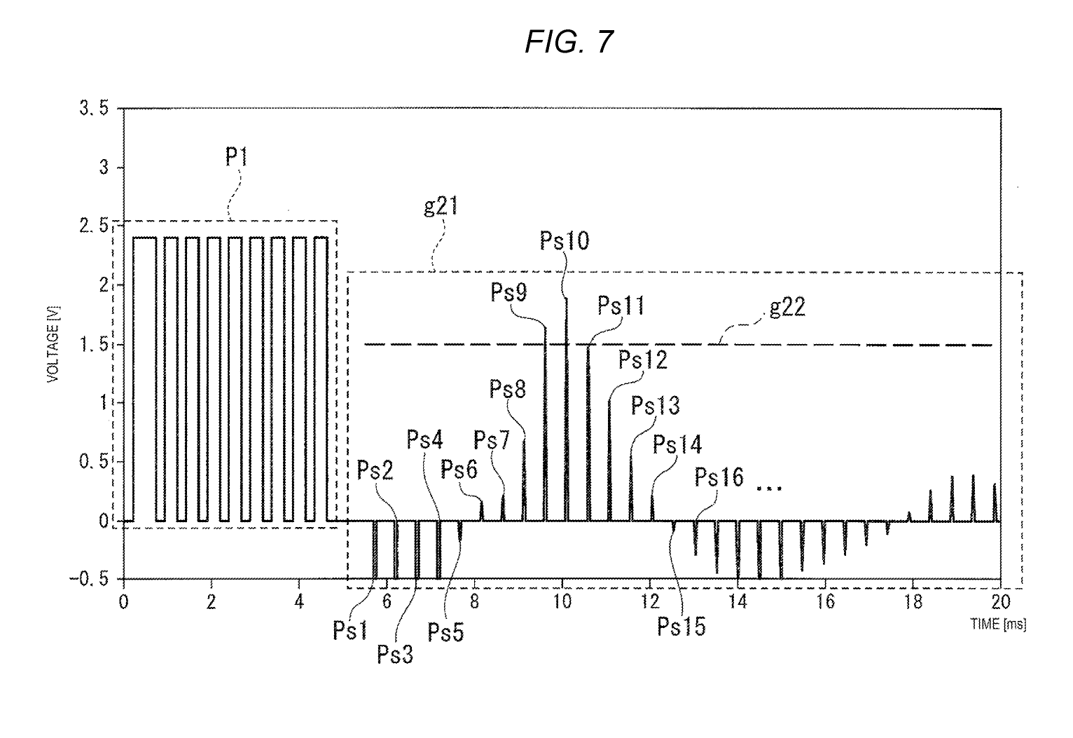

FIG. 7 is a view illustrating an example of the main drive pulse and the induced voltage according to the present embodiment. In FIG. 7, the horizontal axis represents a time ms and the vertical axis represents a signal level V. A region surrounded by a chain line square P1 is a waveform example of the main drive pulse. A region surrounded by a chain line square g21 is a waveform example of the induced voltage generated by the search pulse after the main drive pulse is applied. A chain line g22 represents the threshold voltage Vcomp.

A sign Psn (n is an integer greater than or equal to 1) is the induced voltage generated by an n-th search pulse Spn (FIG. 6). Hereinafter, the induced voltage of the sign Psn will be referred to as an n-th induced voltage.

### Detection Method of Reference Position

Next, a detection method of the reference position will be described.

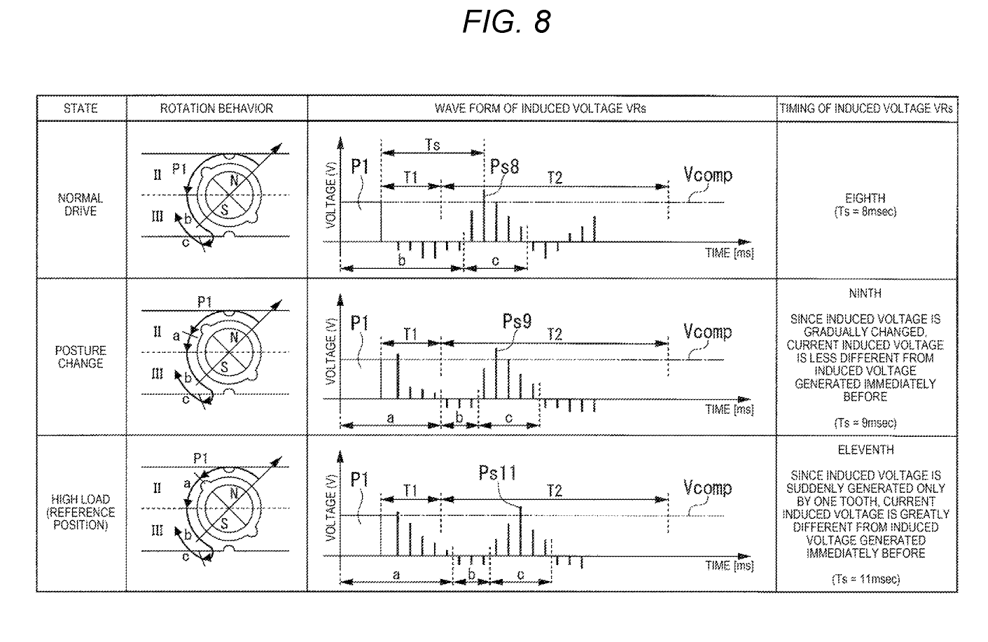

FIG. 8 is a view illustrating an example of a state according to the present embodiment, a rotation behavior of the rotor 202, a waveform of the induced voltage VRs, and a timing of the induced voltage VRs.

In the example illustrated in FIG. 8, three states (normal driving, a posture change, and a high load (reference position)) are illustrated as a behavior of the rotor 202 after the main drive pulse P1 is applied. The normal driving means driving at a position other than the reference position, that is, in the second region illustrated in FIG. 2. The posture change means a state where a dial (not illustrated) of the timepiece 1 is not horizontal. The high load (reference position) means driving in the first region illustrated in FIG. 1.

The timing of the induced voltage VRs shows what number-th is the induced voltage VRs exceeding the threshold voltage Vcomp out of the induced voltages VRs after the main drive pulse P1 is applied.

First, the normal driving will be described.

During the normal driving, the load is normally applied to positions other than the reference position. Accordingly, remaining driving power is sufficient. As a result, as shown in the rotation behavior of the “normal driving” and the waveform of the induced voltage VRs, the drive pulse is discontinued in a second half of a second quadrant II and a region b. Therefore, due to the movement of the rotor 202, the induced voltage VRs is output to a negative side. Subsequently, due to the movement of the rotor 202 in a third quadrant III and a region c, the induced voltage VRs is output to a positive side. The timing of the induced voltage VRs exceeding the threshold voltage Vcomp is the eighth. A sign Ts indicates an elapsed time until the timing of the induced voltage VRs exceeding the threshold voltage Vcomp after the main drive pulse P1 is output.

Next, a case of the posture change will be described.

If the posture of the motor 20 is changed in this way, a distance between the stator 201 and the rotor 202 is not uniform during the rotation period of 360 degrees, and may vary in some cases. As a result, as shown in the rotation behavior of the “posture change” and the waveform of the induced voltage VRs, the drive pulse is discontinued in a second quadrant II and a region a. Accordingly, due to the movement of the rotor 202, the induced voltage VRs is output to the positive side. Subsequently, due to the movement of the rotor 202 in the third quadrant III and the region b, the induced voltage VRs is output to the negative side. Subsequently, due to the movement of the rotor 202 in the third quadrant III and the region c, the induced voltage VRs is output to the positive side. The timing of the induced voltage VRs timing is the ninth.

In the case of the “posture change”, the induced voltage VRs is gradually changed when the indicating hand 40 is rotated every one step. Accordingly, the induced voltage of the previous step and the induced voltage of the current step are less different from each other.

Next, a case where the posture is changed by a high load (reference position) will be described.

In this way, as shown in the rotation behavior and the waveform of the induced voltage VRs in a case of being driven at the reference position, the drive pulse is discontinued in the second quadrant II and the region a. Accordingly, due to the movement of the rotor 202, the induced voltage VRs is output to the positive side. Subsequently, due to the movement of the rotor 202 in the third quadrant III and the region b, the induced voltage VRs is output to the negative side. Subsequently, due to the movement of the rotor 202 in the third quadrant III and the region c, the induced voltage VRs is output to the positive side. The timing of the induced voltage VRs is the eleventh.

However, in a case of the “high load (reference position)”, the induced voltage VRs is suddenly generated only by one tooth if the indicating hand 40 is rotated every one step. Accordingly, the induced voltage VRs of the previous step and the induced voltage VRs of the current step are greatly different from each other.

Therefore, according to the present embodiment, when the motor 20 is driven using the main drive pulse, the position where the induced voltage VRs exceeds the threshold voltage Vcomp is stored. Thereafter, when the motor 20 is driven using the main drive pulse, the position where the induced voltage VRs exceeds the threshold voltage Vcomp is compared with the stored position. According to the present embodiment, as a result of comparison, a position where a position difference is equal to or greater than a predetermined value is determined as the reference position.

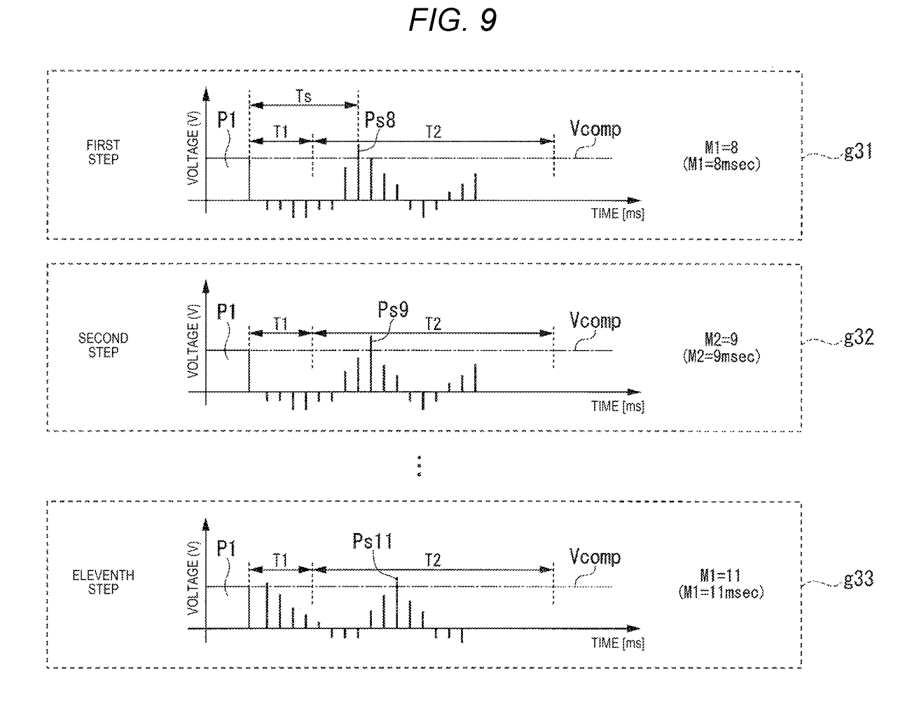

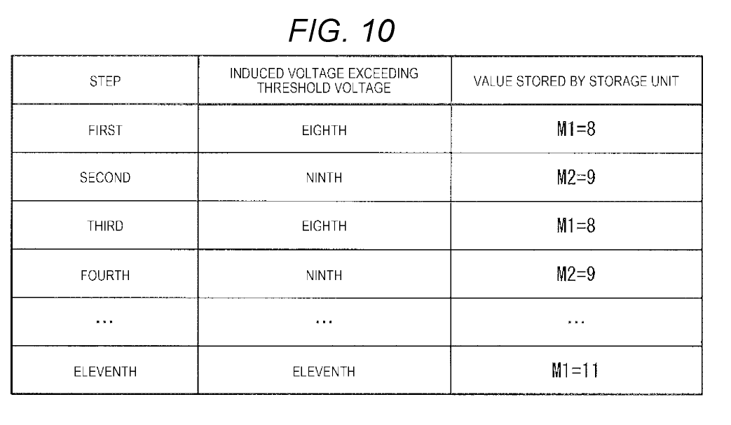

FIG. 9 is a view for describing a detection method of the reference position according to the present embodiment. FIG. 10 is a view illustrating an information example stored in the storage unit 5 according to the present embodiment.

In the example illustrated in FIGS. 9 and 10, the first region is a position of the eleventh step, and the other position is the second region.

First, as illustrated by a sign g31, in the first step, the induced voltage exceeding the threshold voltage Vcomp is the eighth. The control unit 15 causes the storage unit 5 to store the eighth in association with the first step. Furthermore, the control unit 15 causes the storage unit 5 to store M1=8 as a timing information piece.

Next, as illustrated by a sign g32, in the second step, the induced voltage exceeding the threshold voltage Vcomp is the ninth. The control unit 15 causes the storage unit 5 to store the ninth in association with the second step. Furthermore, the control unit 15 causes the storage unit 5 to store M2=9 as the timing information piece. The control unit 15 obtains an absolute value of a difference between M1 and M2 stored in the storage unit 5, and determines whether or not the obtained absolute value is greater than a predetermined value. Here, in a case where the predetermined value is 2, the control unit 15 determines that the position is not the reference position, since the absolute value of the difference is 1 and is equal to or smaller than the predetermined value.

Next, as illustrated by a sign g33, in the eleventh step, the induced voltage exceeding the threshold voltage Vcomp is the eleventh. The control unit 15 causes the storage unit 5 to store the eleventh in association with the eleventh step. Furthermore, the control unit 15 causes the storage unit 5 to store M2=11 as the timing information piece. The control unit 15 obtains the absolute value of the difference between M1 and M2 stored in the storage unit 5, and determines whether or not the obtained absolute value is greater than the predetermined value. The control unit 15 determines that the position is the reference position, since the absolute value of the difference is 3 and is greater than the predetermined value.

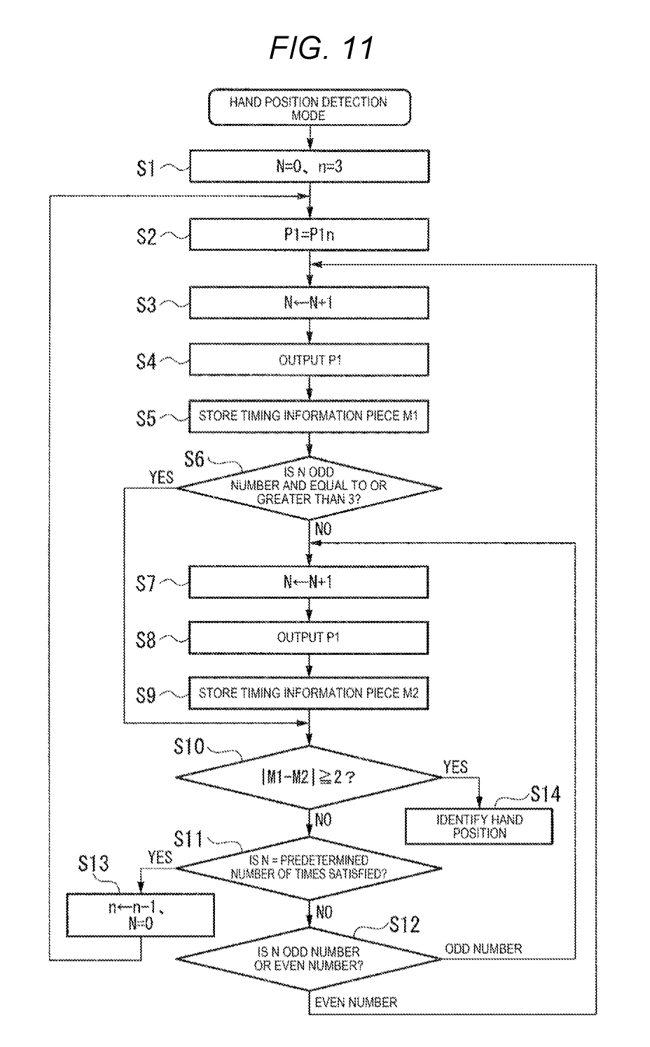

FIG. 11 is a flowchart illustrating a procedure example of detecting the reference position according to the present embodiment.

The following process is performed, for example, when the battery 2 is exchanged or after it is detected that a user operates the operation unit 6 and the hand position control device 10 switches a mode to a hand position detection mode.

(Step S1) The control unit 15 initializes N to 0, and sets n representing a rank of the drive energy to 3.

(Step S2) The control unit 15 sets P1n (n is a rank, and is an integer equal to or greater than 1) to P1.

(Step S3) The control unit 15 adds 1 to N.

(Step S4) The pulse control unit 11 applies the main drive pulse P1 of the rank n.

(Step S5) The rotation detection unit 13 starts counting of the timer unit 131 after the main drive pulse P1 is applied. Subsequently, after the lapse of a mask time T1, the rotation detection unit 13 counts what number-th is the induced voltage VRs equal to or higher than the threshold voltage out of the induced voltages. Subsequently, the control unit 15 causes the storage unit 5 to store the information piece indicating what number-th is the induced voltage VRs equal to or higher than the threshold voltage Vcomp out of the induced voltages, as M1 of the timing information piece. In a case of detecting a plurality of the induced voltages where the induced voltage VRs is equal to or higher than the threshold voltage Vcomp, the control unit 15 causes the storage unit 5 to store the information piece indicating what number-th is the induced voltage detected for the first time.

(Step S6) The control unit 15 determines whether or not N is the odd number and is equal to or greater than 3. When the control unit 15 determines that N is the odd number and is equal to or greater than 3 (Step S6; YES), the control unit 15 proceeds to a process in Step S10. When the control unit 15 determines that N is the even number or is smaller than 3 (Step S6; NO), the control unit 15 proceeds to a process in Step S7.

(Step S7) The control unit 15 adds 1 to N.

(Step S8) The pulse control unit 11 applies the main drive pulse P1 of the rank n.

(Step S9) The rotation detection unit 13 starts counting of the timer unit 131 after the main drive pulse P1 is applied. Subsequently, after the lapse of the mask time T1, the rotation detection unit 13 counts what number-th is the induced voltage VRs equal to or higher than the threshold voltage out of the induced voltages. Subsequently, the control unit 15 causes the storage unit 5 to store the information piece indicating what number-th is the induced voltage VRs equal to or higher than the threshold voltage out of the induced voltages, as M2 of the timing information piece.

(Step S10) The control unit 15 obtains the absolute value of the difference between M1 and M2 stored in the storage unit 5, and determines whether or not the obtained absolute value of the difference is equal to or greater than a predetermined amount, for example, equal to or greater than 2. For example, the predetermined amount described herein is the number of search pulses output during the detection period. When it is determined that the absolute value of the difference is equal to or greater than 2 (Step S10; YES), the control unit 15 proceeds to a process in Step S14. In a case where it is determined that the absolute value of the difference is smaller than 2 (Step S10; NO), the control unit 15 proceeds a process in Step S11. Here, 2 is a predetermined value, which corresponds to approximately 2 ms.

(Step S11) The control unit 15 determines whether or not N is the predetermined number of times. In a case where the control unit 15 determines that N is the predetermined number of times (Step S11; YES), the control unit 15 proceeds to the process in Step S13. In a case where the control unit 15 determines that N is not the predetermined number of times (Step S11; NO), the control unit 15 proceeds to the process in Step S12.

(Step S12) The control unit 15 determines whether N is the odd number or the even number. In a case where the control unit 15 determines that N is the odd number (Step S12; the odd number), the control unit 15 returns to the process in Step S7. In a case where the control unit 15 determines that N is the even number (Step S12; the even number) the control unit 15 returns to the process in Step S3.

(Step S13) The control unit 15 cannot detect the reference position within a predetermined number of times. Accordingly, the control unit 15 determines that the drive energy of the main drive pulse was too strong, subtracts 1 from n, lowers the rank of the drive energy as much as 1, and initializes N to 0. After the process is performed, the pulse control unit 11 returns to the process in Step S2.

(Step S14) The control unit 15 determines a position determined that the absolute value is greater than 2, as the reference position.

As described above, the control unit 15 completes the process in the hand position detection mode, and switches a mode to a normal hand operation mode for displaying the time.

Here, a specific example of the process in FIG. 11 will be described with reference to FIG. 9 as an example.

In an operation of the first step (first tooth in the gear), a timing information piece M1=8 (N=1) is stored in the storage unit 5.

In an operation of the second step (second tooth in the gear), a timing information piece M2=9 (N=2) is stored in the storage unit 5.

The control unit 15 determines whether or not the absolute value of the difference between the timing information piece M2 stored in the storage unit 5 and the timing information piece M1 obtained immediately before is equal to or greater than 2. Since the absolute value of the difference is not equal to or greater than 2, the control unit 15 returns to the process in Step S3.

In an operation of the third step (third tooth in the gear), a timing information piece M1=8 (N=3) is stored in the storage unit 5.

The control unit 15 determines whether or not the absolute value of the difference between the timing information piece M1 stored in the storage unit 5 and the timing information piece M2 obtained immediately before is equal to or greater than 2. Since the absolute value of the difference is not equal to or greater than 2, the control unit 15 returns to the process in Step S7.

Thereafter, the control unit 15 repeats the above-described process until the absolute value of the difference between the timing information piece M1 and the timing information piece M2 is equal to or greater than 2.

The above-described process is an example, and the present invention is not limited thereto. The control unit 15 may compare the two timing information pieces with each other. For example, in the above-described example, a case has been described where the control unit 15 stores and overwrites the two timing information pieces (for example, the timing information pieces M1 and M2). However, all of the timing information pieces during the detection period of the reference position may be stored, or a predetermined number of the timing information pieces may be stored. In this case, for example, the control unit 15 may compare the timing information piece M1 stored in the third step with the timing information piece M1 stored in the first step, instead of the information obtained immediately before.

In the above-described example, a case has been described where what number-th is the induced voltage VRs equal to or higher than the threshold voltage Vcomp is stored as the timing information piece. However, the present invention is not limited thereto. As the timing information piece where the induced voltage VRs is equal to or higher than the threshold voltage Vcomp, the control unit 15 may store the elapsed time after the main drive pulse P1 is applied or the elapsed time from the mask time. In this case, the control unit 15 may compare the absolute value of the difference of the elapsed times with a predetermined value. The predetermined value in this case is 2 msec, for example. Here, 2 or 2 ms of the predetermined value to be compared with the absolute value of the difference is an example, and the present invention is not limited thereto. The predetermined value may be a value to be set depending on performance of the motor 20 or a load of the train wheel 30.

As described above, according to the present embodiment, while the indicating hand 40 is rotated one round, the tooth is first rotated one step by using the main drive pulse of the drive energy of the rank having an initial value. Then, after the main drive pulse is applied, information based on the timing at which the induced voltage VRs is equal to or higher than the threshold voltage Vcomp is stored in the storage unit 5. The hand position control device 10 stores the outputting timing of the induced voltage obtained immediately before, and compares the outputting timing with the subsequent timing. In this manner, a position where misalignment is detected as much as or more than a predetermined amount (for example, equal to or more than 2) is regarded as the hand position.

The load of the train wheel 30 according to the present embodiment is in a level which can drive the train wheel 30 without using the correction drive pulse. As a result, as described with reference to FIG. 8, there is a clear difference between the induced voltage during the normal hand operation and the induced voltage when the reference position is detected. Accordingly, the timings are misaligned with each other as much as or more than two. Other loads, the hand inclination such as the posture, and aged deterioration have continuity. Accordingly, the timings are not instantaneously misaligned with each other as much as or more than two. The two timings correspond to approximately 2 msec. Therefore, according to the present embodiment, the hand position corresponding to the load position can be identified, based on this timing misalignment, even though a slight load is applied to the load position to such an extent that the correction drive pulse is not used.

In the above-described example, a case has been described where what number-th is the induced voltage equal to or higher than the threshold voltage Vcomp is counted after the main drive pulse P1 is applied. However, the induced voltages after the mask time T1 may be counted.

Second Embodiment

In a case where the timepiece 1 is exposed to a magnetic field, the motor 20 is affected by the magnetic field. In this case, since the motor 20 is configured as illustrated in FIG. 3, generation patterns of the waveforms of the induced voltage VRs are different from each other between a magnetic pole direction which assists the rotation of the rotor and a magnetic pole direction which interferes with the rotation of the rotor. Therefore, in the present embodiment, the timings at which the induced voltages VRs are equal to or higher than the threshold voltage Vcomp are compared with each other for each polarity.

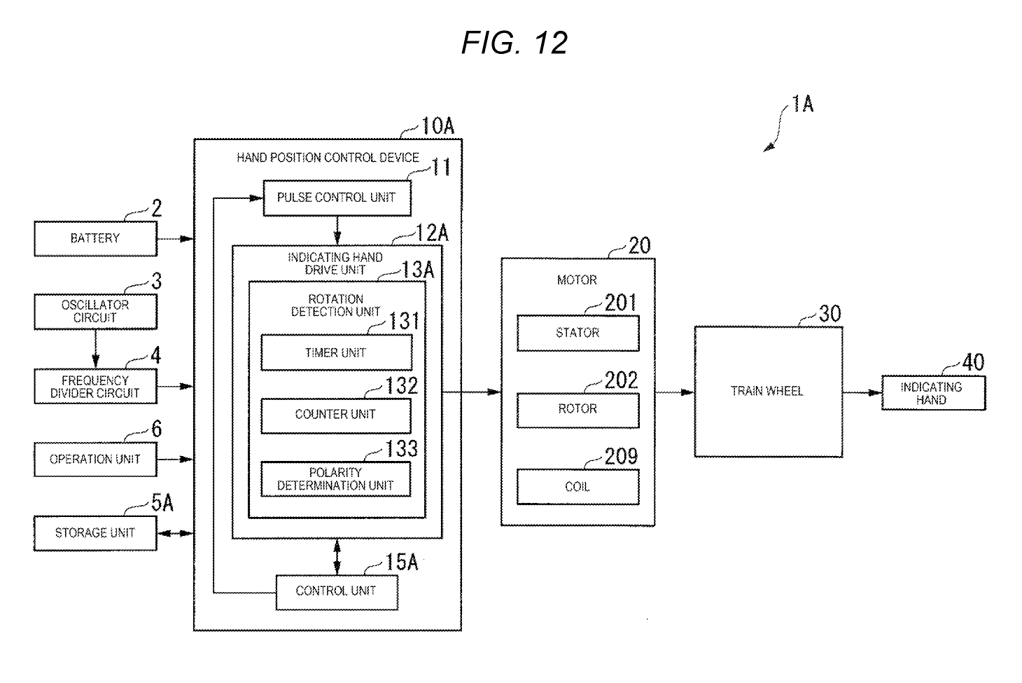

FIG. 12 is a block diagram illustrating a configuration example of a timepiece 1A according to the present embodiment. As illustrated in FIG. 12, the timepiece 1A includes the battery 2, the oscillator circuit 3, the frequency divider circuit 4, a storage unit 5A, the operation unit 6, a hand position control device 10A (hand position identification device), the motor 20, the train wheel 30, and the indicating hand 40.

The hand position control device 10A includes the pulse control unit 11, an indicating hand drive unit 12A, and a control unit 15A. The indicating hand drive unit 12A includes a rotation detection unit 13A. The rotation detection unit 13A includes the timer unit 131, the counter unit 132, and a polarity determination unit 133.

The same reference numerals will be given to functional units having a function which is the same as that of the timepiece 1, and description thereof will be omitted.

The storage unit 5A stores the main drive pulse and the correction drive pulse. The storage unit 5A stores the mask time and the timing information piece. The storage unit 5A stores the timing information piece indicating what number-th is the induced voltage exceeding the threshold voltage after the main drive pulse is applied when the reference position is detected, in association with polarities (first polarity and second polarity) each time the indicating hand 40 is rotated. The information pieces stored in the storage unit 5A will be described later.

In addition to the operation of the rotation detection unit 13, the rotation detection unit 13A switches the information pieces indicating the polarities (first polarity and second polarity) of the motor 20 when the reference position is detected, each time the main drive pulse is output, and outputs the information pieces indicating the polarities of the motor 20 to the control unit 15A.

The polarity determination unit 133 switches the information pieces indicating the polarities (first polarity and second polarity) of the motor 20, each time the main drive pulse output from the pulse control unit 11 is instructed, when the reference position is detected.

The control unit 15A causes the storage unit 5A to store the timing information piece output by the rotation detection unit 13A, when the reference position is detected, in association with the information piece indicating the polarity. The control unit 15A compares the timing information pieces having the same polarity at different positions with each other out of the timing information pieces stored in the storage unit 5A, when the reference position is detected, and determines reference position, based on the comparison result. A method of determining the reference position will be described later.

Next, an information example stored in the storage unit 5A will be described.

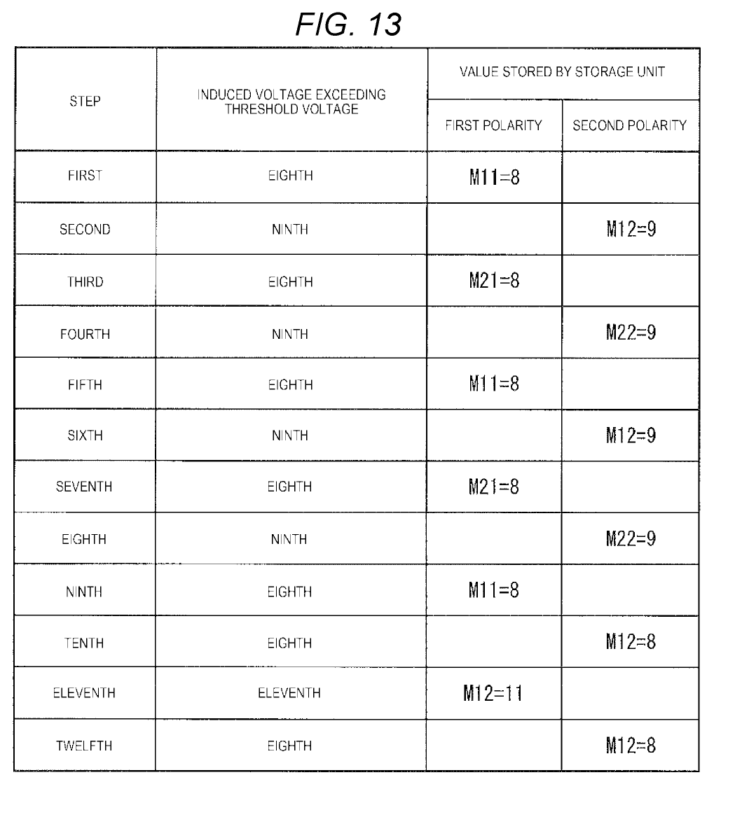

FIG. 13 is a view illustrating the information example stored in the storage unit 5A according to the present embodiment. As illustrated in FIG. 13, the storage unit 5A stores the timing information piece for each of the polarities (first polarity and second polarity).

Specifically, the storage unit 5A stores the timing information piece of the first step, as a timing information piece M11=8 of the first polarity, and stores the timing information piece of the second step, as a timing information piece M12=9 of the second polarity. Thereafter, the storage unit 5A stores the timing information piece of the (2p−1)-th step (p is an integer equal to or greater than 2), as a timing information piece M21 of the first polarity, and stores the timing information piece of the (2p)-th step, as a timing information piece M22 of the second polarity.

The control unit 15A compares an absolute value of a difference between the timing information pieces M11 and M21 of the first polarity with a predetermined value. Furthermore, the control unit 15A compares the absolute value of the difference between the timing information pieces M12 and M22 of the second polarity with the predetermined value. The control unit 15A then determines a position where the absolute value of the difference is equal to or greater than the predetermined value, as the reference position.

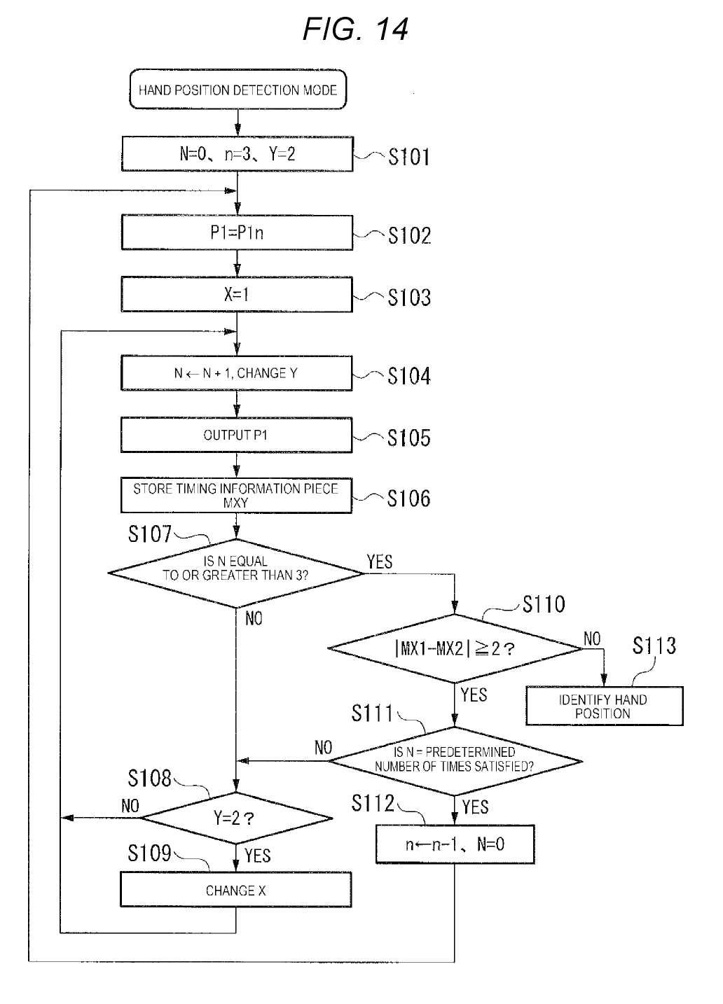

FIG. 14 is a flowchart illustrating a procedure example of detecting the reference position according to the present embodiment.

The following process is performed, for example, when the battery 2 is exchanged or after it is detected that a user operates the operation unit 6 and the hand position control device 10A switches a mode to a hand position detection mode.

(Step S101) The control unit 15A initializes N to 0, sets n indicating the rank of the drive energy to 3, and sets Y to 2.

(Step S102) The control unit 15A sets a main drive pulse P1n of the rank n (n is rank, and is an integer equal to or greater than 1) to the main drive pulse P1.

(Step S103) The control unit 15A sets X to 1.

(Step S104) The control unit 15A adds 1 to N, and changes a value of Y. Specifically, the control unit 15A changes Y to 1 if Y is 2, and changes Y to 2 if Y is 1.

(Step S105) The pulse control unit 11 applies the main drive pulse P1 to the motor 20.

(Step S106) The rotation detection unit 13A starts counting of the timer unit 131 after the main drive pulse P1 is applied. Subsequently, after the lapse of the mask time T1, the rotation detection unit 13A counts what number-th is the induced voltage VRs equal to or higher than the threshold voltage out of the induced voltages. Subsequently, the control unit 15A causes the storage unit 5A to store the information piece indicating what number-th is the induced voltage VRs equal to or higher than the threshold voltage out of the induced voltages, as a timing information piece MXY of the X-th polarity.

(Step S107) The control unit 15A determines whether or not N is 3. In a case where it is determined that N is equal to or greater than 3 (Step S107; YES), the control unit 15A proceeds to a process in Step S110. In a case where it is determined that N is smaller than 3 (Step S107; NO), the control unit 15A proceeds to a process in Step S108.

(Step S108) The control unit 15A determines whether or not Y is equal to or greater than 2. In a case where it is determined that Y is 2 (Step S108; YES), the control unit 15A proceeds to a process in Step S109. In a case where it is determined that Y is not 2 (Step S108; NO), the control unit 15A returns the process in Step S104.

(Step S109) The control unit 15A changes a value of X. Specifically, the control unit 15A changes X to 2 if X is 1, and changes X to 1 if X is 2. After the process is performed, the control unit 15A returns to the process in Step S104.

(Step S110) The control unit 15A obtains the absolute value of the difference between timing information pieces MX1 and MX2 of the X-th polarity which are stored in the storage unit 5, and determines whether or not the obtained absolute value of the difference is equal to or greater than 2. In a case where the control unit 15A determines that the absolute value of the difference is equal to or greater than 2 (Step S110; YES), the control unit 15A proceeds to a process in Step S111. In a case where the control unit 15A determines that the absolute value of the difference is smaller than 2 (Step S110; NO), the control unit 15A proceeds to a process in Step S113. Here, 2 is a predetermined value, which corresponds to approximately 2 ms.

(Step S111) The control unit 15A determines whether or not N is the predetermined number of times. In a case where the control unit 15A determines that N is the predetermined number of times (Step S111; YES), the control unit 15A proceeds to a process in Step S112. In a case where the control unit 15A determines that N is not the predetermined number of times (Step S111; NO), the control unit 15A proceeds to a process in Step S108.

(Step S112) The control unit 15A cannot detect the reference position within the predetermined number of times. Accordingly, the control unit 15A determines that the drive energy of the main drive pulse is too strong, subtracts 1 from n, lowers the rank of the drive energy as much as 1, and initializes N to 0.

After the process is performed, the pulse control unit 11 returns to the process in Step S102.

(Step S113) The control unit 15A determines a position determined that the absolute value is greater than 2, as the reference position.

As described above, the control unit 15A completes the process in the hand position detection mode, and switches a mode to the normal hand operation mode for displaying the time.

Here, a specific example of a process in FIG. 14 will be described with reference to FIG. 13 as an example.

In an operation of the first step (first tooth in the gear), the control unit 15A sets X to 1, adds 1 to N, and changes Y from 2 to 1. Thereafter, the control unit 15A causes the storage unit 5A to store the timing information piece M11 (X=1, Y=1, N=1). Since N is equal to or smaller than 3 and Y is not 2, the control unit 15A returns to the process in Step S104.

In an operation of the second step (second tooth in the gear), the control unit 15A adds 1 to N, and changes Y from 1 to 2. Thereafter, the control unit 15A causes the storage unit 5A to store the timing information piece M12 (X=1, Y=2, N=2). Since N is smaller than 3 and Y is 2, the control unit 15A changes X from 1 to 2, and thereafter, returns to the process in Step S104.

In an operation of the third step (third tooth in the gear), the control unit 15A adds 1 to N, and changes Y from 2 to 1. Thereafter, the control unit 15A causes the storage unit 5A to store the timing information piece M21 (X=2, Y=1, N=3). Since the number N is equal to or greater than 3, the control unit 15A proceeds to the process in Step S110.

The control unit 15A determines whether or not the absolute value of the difference between the timing information piece M21 (third) stored in the storage unit 5A and the timing information piece M11 (first) having the same polarity is equal to or greater than 2. Since the absolute value is not equal to or greater than 2, N is not the predetermined number of times, and Y is not 2, the control unit 15A returns to the process in Step S108. Subsequently, since Y is not 2, the control unit 15A returns to the process in Step S104.

In an operation of the fourth step (fourth tooth in the gear), the control unit 15A adds 1 to N, and changes Y from 1 to 2. Thereafter, the control unit 15A causes the storage unit 5A to store the timing information piece M22 (X=2, Y=2, N=4). Since N is equal to or greater than 3, the control unit 15A proceeds to the process in Step S110.

The control unit 15A determines whether or not the absolute value of the difference between the timing information piece M22 (fourth) stored in the storage unit 5A and the timing information piece M12 (second) having the same polarity is equal to or greater than 2. Since the absolute value is not equal to or greater than 2, and N is not the predetermined number of times, the control unit 15A returns to the process in Step S108. Subsequently, since Y is 2, the control unit 15A changes X from 2 to 1, and thereafter, returns to the process in Step S104.

In an operation of the fifth step (fifth tooth in the gear), the control unit 15A adds 1 to N, and changes Y from 2 to 1. Thereafter, the control unit 15A causes the storage unit 5A to store the timing information piece M11 (X=1, Y=1, N=5). Since N is equal to or greater than 3, the control unit 15A proceeds to the process in Step S110.

The control unit 15A determines whether or not the absolute value of the difference between the timing information piece M11 (fifth) stored in the storage unit 5A and the timing information piece M21 (third) having the same polarity is equal to or greater than 2. Since the absolute value is not equal to or greater than 2 and N is not the predetermined number of times, the control unit 15A returns to the process in Step S108. Subsequently, since Y is not 2, the control unit 15A returns to the process in Step S104.

In an operation of the sixth step (sixth tooth in the gear), the control unit 15A adds 1 to N, and changes Y from 1 to 2. Thereafter, the control unit 15A causes the storage unit 5A to store the timing information piece M12 (X=1, Y=2, N=6). Since N is equal to or greater than 3, the control unit 15A proceeds to the process in Step S110.

The control unit 15A determines whether or not the absolute value of the difference between the timing information piece M12 (sixth) stored in the storage unit 5A and the timing information piece M22 (fourth) having the same polarity is equal to or greater than 2. Since the absolute value is not equal to or greater than 2 and N is not the predetermined number of times, the control unit 15A returns to the process in Step S108. Subsequently, since Y is not 2, the control unit 15A changes X from 1 to 2, and thereafter, returns to the process in Step S104.

Thereafter, the control unit 15A repeats the above-described process until the absolute value of the difference between the timing information piece M1 and the timing information piece M2 is equal to or greater than 2. The control unit 15A causes the storage unit 5A to store the above-described N, X, and Y when the reference position is detected.

The above-described process is an example, and the present invention is not limited thereto. The control unit 15A may compare the same polarities with each other. For example, in the above-described example, a case has been described where the control unit 15A stores and overwrites the two timing information pieces (for example, the timing information pieces M11 and M21) for each polarity. However, all of the timing information pieces obtained during the period of detecting the reference position may be stored, or a predetermined number of the timing information pieces may be stored. In this case, for example, the control unit 15A may compare the timing information piece M11 stored in the fifth step with the timing information piece M11 stored in the first step.

In the above-described example, a case has been described where what number-th is the induced voltage VRs equal to or higher than the threshold voltage Vcomp is stored as the timing information piece. However, the present invention is not limited thereto. The control unit 15A may store the elapsed time after the main drive pulse P1 is applied or the elapsed time after the mask time, for example, as the timing information piece where the induced voltage VRs is equal to or higher than the threshold voltage Vcomp. In this case, the control unit 15A may compare the absolute value of the difference between the elapsed times with a predetermined value. The predetermined value in this case is 2 msec, for example. Here, 2 (or 2 ms) of the predetermined value to be compared with the absolute value of the difference is an example, and the present invention is not limited thereto. The predetermined value may be a value to be set depending on the performance of the motor 20 or the load of the train wheel 30.

As described above, according to the present embodiment, the time information piece indicating what number-th is the induced voltage exceeding the threshold voltage after the main drive pulse is applied is stored for each polarity, and other optional information pieces are compared to each other for each polarity. In this manner, according to the present embodiment, even in a case where the timepiece 1 is affected by the magnetic field, even though a slight load is applied to the load position to such an extent that the correction drive pulse is not used, the hand position corresponding to the load position can be identified.

In the above-described example, a case has been described where what number-th is the induced voltage equal to or higher than the threshold voltage Vcomp is counted after the main drive pulse P1 is applied. However, the induced voltages obtained after the mask time T1 may be counted.

Third Embodiment

In the first embodiment and the second embodiment, an example has been described in which the mask time is set after the main drive pulse is applied to the motor 20. However, according to the present embodiment, the mask time may not be provided. In the present embodiment, an example applicable to the first embodiment will be described. However, as a matter of course, the example is also applicable to the second embodiment.

A configuration of the timepiece 1 in a case where the third embodiment is applied to the first embodiment is the same as that in FIG. 1. However, the rotation detection unit 13 does not employ the timer unit 131 when the reference position is detected. The counter unit 132 counts what number-th is the induced voltage exceeding the threshold voltage, at any time in addition to the time at which the induced voltage exceeds the threshold value for the first time, and outputs the result to the control unit 15.

In a case where two or more induced voltages exceeding the threshold voltage are counted in one rotation, the control unit 15 determines the reference position by comparing the closely generated timing information pieces with each other.

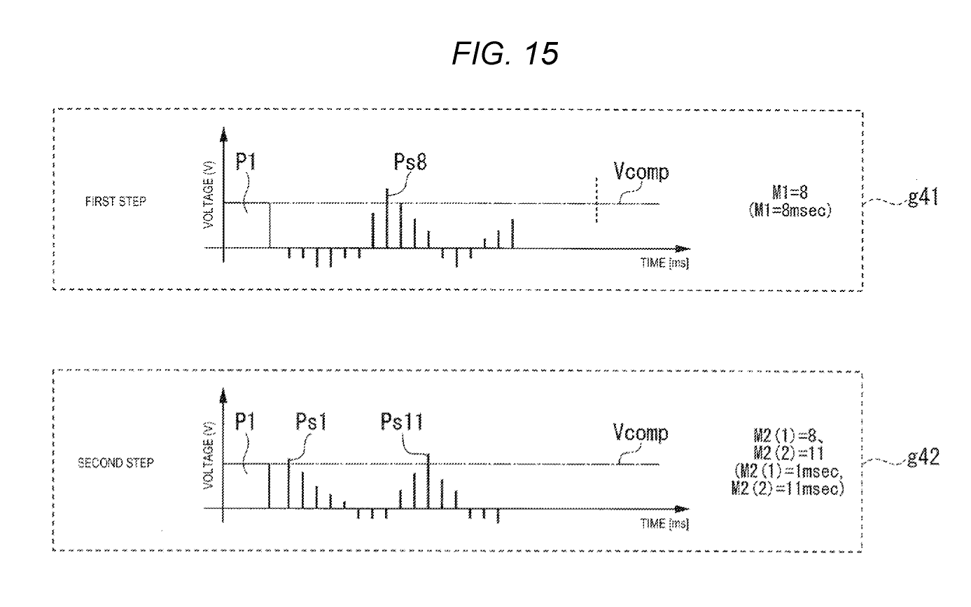

FIG. 15 is a view illustrating an example of the timing information piece according to the present embodiment.

In an example illustrated in FIG. 15, the first region is a second step position and the other position is the second region.

First, as illustrated by a sign g41, in the first step, the induced voltage exceeding the threshold voltage Vcomp is only the eighth. The control unit 15 causes the storage unit 5 to store the eighth in association with the first step. Furthermore, the control unit 15 causes the storage unit 5 to store M1=8, as the timing information piece. A sign Ts indicates the elapsed time until the timing of the induced voltage VRs exceeding the threshold voltage Vcomp after the main drive pulse P1 is output.

Next, as illustrated by a sign g42, in the second step, the induced voltages exceeding the threshold voltage Vcomp are the first and the eleventh. The control unit 15 causes the storage unit 5 to store the first and the eleventh in association with the second step. Furthermore, the control unit 15 causes the storage unit 5 to store M2(1)=1 and M2(2)=11, as the timing information piece.

The control unit 15 determines which one of the timing information pieces M2(1)=1 and M2(2)=11 stored in the storage unit 5 in the second step is closer to the timing information piece M1=8 stored in the storage unit 5 in the most recent first step. In this case, the timing information piece M2(2)=11 is closer to the timing information piece M1=8. Accordingly, the control unit 15 determines the reference position by comparing the absolute value of the difference between the timing information piece M2(2)=11 and the timing information piece M1=8, and 2 with each other.

In a case where a plurality of the timing information pieces are detected in the first step, the control unit 15 determines which one of the plurality of timing information pieces in the first step is closer to the most recent second timing information piece.

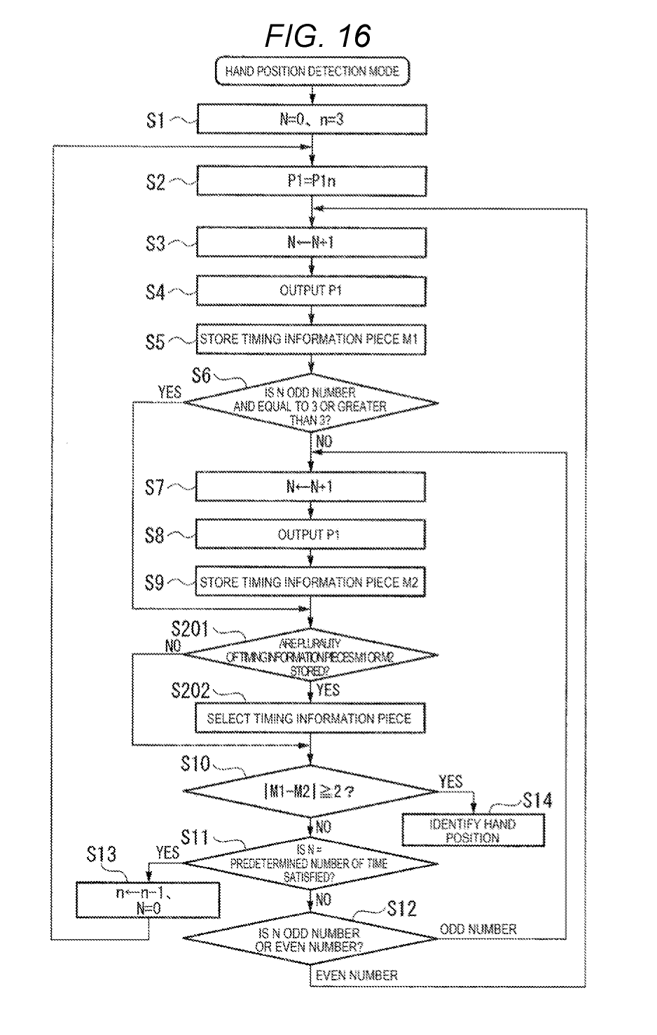

FIG. 16 is a flowchart illustrating a procedure example of detecting the reference position according to the embodiment. The same reference numerals will be used for the processes which are the same as those of the first embodiment (FIG. 11), and description thereof will be omitted.

(Steps S1 to S9) The hand position control device 10 performs the processes in Steps S1 to S9. After the processes are performed, the control unit 15 proceeds to the process in Step S201.

(Step S201) The control unit 15 determines whether a plurality of the timing information pieces M1 are stored in the storage unit 5. Subsequently, the control unit 15 determines whether a plurality of the timing information piece M2 are stored in the storage unit 5. In a case where it is determined that the plurality of timing information pieces M1 or M2 are stored (Step S201; YES), the control unit 15 proceeds to the process in Step S202. In a case where the timing information pieces M1 and M2 are stored one by one (Step S201; NO), the control unit 15 proceeds to the process in Step S10.

(Step S202) In a case where it is determined that the plurality of timing information pieces M1 are stored, the control unit 15 selects one of the timing information pieces M1, which is closer to a value of the timing information piece M2. Alternatively, in a case where it is determined that the plurality of timing information pieces M2 are stored, the control unit 15 selects one of the timing information pieces M2, which is closer to a value of the timing information piece M1. After the process is performed, the control unit 15 proceeds to the process in Step S10.

(Step S10) In a case where the plurality of timing information pieces M1 or M2 are stored, the control unit 15 determines whether or not the absolute value of the difference is equal to or greater than 2 by using the timing information piece selected in Step S202. Alternatively, in a case where the timing information pieces M1 and M2 are stored one by one, the control unit 15 determines whether or not the absolute value of the difference is equal to or greater than 2 by using the timing information pieces M1 and M2 stored in the storage unit 5.

According to the third embodiment, the timing information piece may also be the elapsed time after the main drive pulse is applied, instead of the information piece indicating what number-th is the induced voltages exceeding the threshold voltage.

As described above, according to the present embodiment, in a case where the plurality of timing information pieces are present at two positions, one timing information piece closer to the most recent timing information piece is selected. That is, according to the present embodiment, out of the plurality of timing information pieces, the timing information piece other than a proper timing information piece is excluded as noise. In this manner, according to the present embodiment, even in a case where the induced voltages exceed the threshold voltage at the timing other than the original timing (original step) due to the posture change, the timing information pieces are excluded as the noise. Therefore, the reference position can be detected using the proper timing information piece.

Fourth Embodiment

Unlike the first embodiment, the second embodiment, and the third embodiment, a case will be described where the induced voltage exceeding the threshold voltage Vcomp is not detected by the rotation detection unit 13.

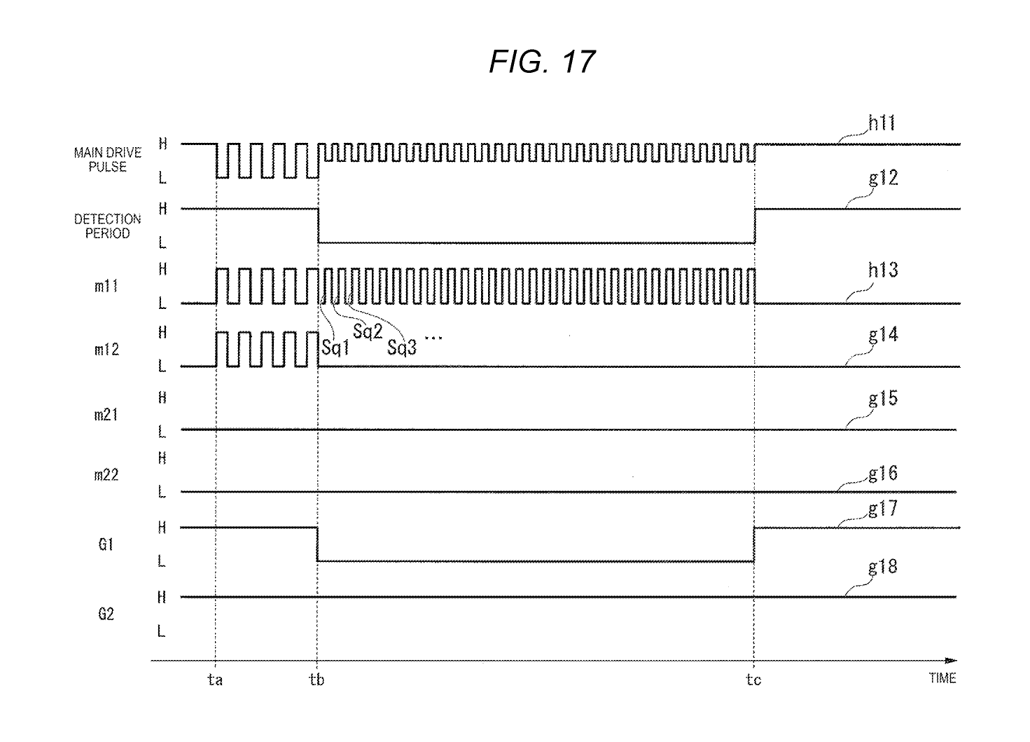

FIG. 17 is a view illustrating an example of the main drive pulse and the detection period according to a fourth embodiment. During a period of times tb to tc illustrated in FIG. 17, that is, during the detection period, a detection pulse included in a waveform h11 and pulses Sq1, Sq2, Sq3, and so forth which are included in a waveform h13 are output. The pulses Sq1, Sq2, Sq3, and so forth are search pulses. A cycle of the pulses Sq1, Sq2, Sq3, and so forth is ½ of a cycle of the pulses Sp1, Sp2, Sp3, and so forth which are illustrated in FIG. 6.

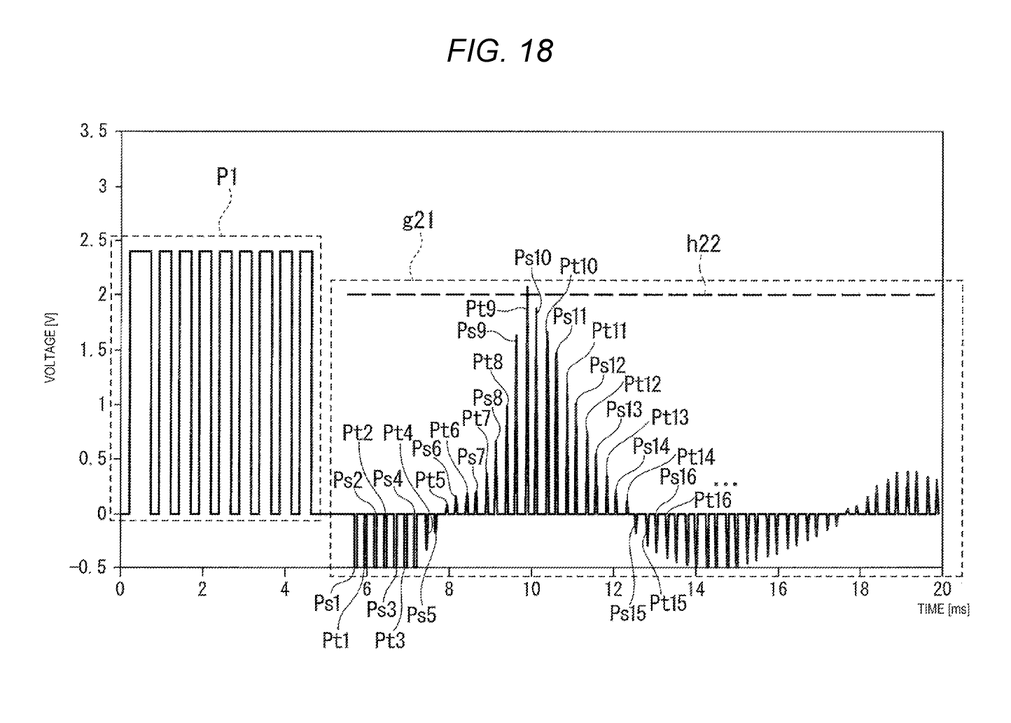

FIG. 18 is a view illustrating an example of the main drive pulse and the induced voltage according to the fourth embodiment. As illustrated in FIG. 18, the rotation detection unit 13 alternately switches between a low impedance state and a high impedance state at the cycle of ½ of the cycle in a case of the first embodiment, by using the pulses Sq1, Sq2, Sq3, and so forth. In this manner, as illustrated in FIG. 18, in addition to the induced voltage illustrated in FIG. 7 by the sign Psn (n is an integer equal to or greater than 1) described above in the case of the first embodiment, the induced voltage illustrated by a sign Ptn (n is an integer equal to or greater than 1) in FIG. 18 is output. The induced voltage is output multiple times, thereby decreasing an electromagnetic braking force applied to the rotor 202. Therefore, the rotor 202 is rotated forward beyond a stationary position determined by the cutout portions 204 and 205. Thereafter, the rotation speed increases when the rotor 202 is rotated rearward to face the stationary position, thereby outputting a high induced voltage. Therefore, even in a case where the threshold voltage Vcomp illustrated by a chain line h22 in FIG. 18 is higher than the threshold voltage Vcomp illustrated by a chain line g22 in FIG. 7, an induced voltage Pt9 output using a pulse Sq9 exceeds the threshold voltage Vcomp.

As described above, according to the present embodiment, in a case where the rotation detection unit 13 does not detect the induced voltage exceeding the predetermined threshold, the rotation detection unit 13 shortens the cycle for alternately switching between the low impedance state and the high impedance state until the induced voltage exceeding the predetermined threshold is detected. In this manner, the hand position control device 10 causes the storage unit 5 to reliably store the timing information piece, and performs the above-described processes. Accordingly, it is possible to achieve an advantageous effect which is the same as that of the hand position control device 10 according to the first embodiment, the second embodiment, or the third embodiment. According to the present embodiment, the number of the output induced voltages are larger than that in the first embodiment, the second embodiment, and the third embodiment. Therefore, according to the present embodiment, the probability that the induced voltage exceeding the threshold voltage Vcomp may be output increases.

Accordingly, the probability of achieving the advantageous effect which is the same as that of the hand position control device 10 according to the first embodiment, the second embodiment, or the third embodiment increases.

In a case where the induced voltage exceeding the predetermined threshold is not detected by the rotation detection unit 13, the control unit 15 may increase the drive energy of the drive pulse until the induced voltage is equal to or smaller than the predetermined threshold in the first region where the indicating hand 40 is located at the reference position, and until a load received by the rotor exceeds the induced voltage in the second region in which the load is lower than that of the first region. The predetermined threshold described herein is the above-described threshold voltage Vcomp, for example. As an example of increasing the drive energy of the drive pulse, raising the rank of the drive pulse may be used.

In this manner, the hand position control device 10 increases the rotation speed of the rotor 202 even in a case where the load received by the rotor 202 increases for reasons other than that the indicating hand 40 is located at the reference position. Accordingly, the hand position control device 10 can generate the induced voltage exceeding the threshold voltage Vcomp in the first region, and can generate the induced voltage equal to or lower than the threshold voltage Vcomp in the second region. In this case, the hand position control device 10 can identify the reference position, even if the reference position is not recognized for the reason of increasing viscosity of the lubricant applied to the tooth of the gear configuring the train wheel 30.

In a case where the rotation detection unit 13 does not detect the predetermined threshold, for example, the induced voltage exceeding the threshold voltage Vcomp, the rotation detection unit 13 may generate another predetermined threshold which is smaller than the predetermined threshold. In this case, the storage unit 5 stores the timing information piece relating to the timing at which the induced voltage exceeds another predetermined threshold, for example, the threshold voltage which is lower than the threshold voltage Vcomp. As an example of the threshold voltage which is lower than the threshold voltage Vcomp, a voltage of ½ or ⅓ of the threshold voltage Vcomp, and a voltage which is slightly higher than that of the noise may be used.

In this manner, the hand position control device 10 causes the storage unit 5 to reliably store the timing information piece, and performs the above-described processes. In this manner, it is possible to achieve the advantageous effect which is the same as that of the hand position control device 10 according to the first embodiment, the second embodiment, or the third embodiment.

A program for entirely or partially realizing functions of the hand position control device 10 (or 10A) according to the present invention may be recorded on a computer-readable recording medium, and the program recorded on the recording medium may be read and executed by a computer system so as to entirely or partially perform the processes performed by the hand position control device 10 (or 10A). The “computer system” described herein includes an OS or hardware such as a peripheral device. The “computer system” also includes a WWW system including a website providing environment (or a display environment). Further, the “computer-readable recording medium” includes a portable medium such as a flexible disk, a magneto-optical disk, a ROM, and a CD-ROM, and a storage device such as a hard disk incorporated in the computer system. Furthermore, the “computer-readable recording medium” includes those which hold a program for a prescribed period of time, such as a volatile memory (RAM) inside the computer system serving as a server or a client in a case where the program is transmitted via a network such as the Internet or a communication line such as a telephone line.

The above-described program may be transmitted from the computer system in which the program is stored in the storage device to another computer system via a transmission medium or by using a transmission wave in the transmission medium. Here, the “transmission medium” for transmitting the program means a medium having a function to transmit information such as a network (communication network) such as the Internet and a communication line (communication cable) such as a telephone line. The above-described program may be provided in order to partially realize the above-described functions.

Furthermore, the above-described program may be a so-called difference file (differential program) which can realize the above-described functions in combination with the program previously recorded in the computer system.

Hitherto, forms for embodying the present invention has been described with reference to the embodiments. However, the present invention is not limited to the embodiments at all. Various modifications and substitutions can be additionally made within the scope not departing from the gist of the present invention.

What is claimed is:

1. A hand position identification device comprising:
a rotation detection unit that detects a rotation state of a rotor by using an induced voltage generated in a coil of a motor for rotating an indicating hand after a drive pulse is output to the coil;
a storage unit that stores a timing information piece relating to a timing at which the induced voltage exceeds a predetermined threshold; and
a control unit that compares a first timing information piece stored in the storage unit, which is a timing information piece obtained in a case where the indicating hand is located at a first indicating hand position, with a second timing information piece which is a timing information piece obtained in a case where the indicating hand is located at a second indicating hand position, and that identifies the second indicating hand position as an identified position in a case where a difference between the first timing information piece and the second timing information piece is equal to or more than a predetermined amount.

2. The hand position identification device according to claim 1, wherein the predetermined amount is equivalent to two search pulses output during a period while the rotation detection unit detects the rotation state of the rotor.

3. The hand position identification device according to claim 1, wherein the storage unit stores the timing information piece for each polarity of the rotor, and wherein the control unit compares the first timing information piece obtained in a case where the indicating hand is located at the first indicating hand position and in a case where the rotor has a first polarity, with the second timing information piece obtained in a case where the indicating hand is located at the second indicating hand position and in a case where the rotor has the first polarity, and the control unit identifies the second indicating hand position as the identified position in a case where a difference between the first timing information piece and the second timing information piece is equal to or more than the predetermined amount.

4. The hand position identification device according to claim 1, wherein the storage unit stores a plurality of the timing information pieces in a case where a plurality of the timing information pieces are present at one indicating hand position, and wherein in a case where a plurality of the second timing information pieces are present, the control unit selects the second timing information piece closer to the first timing information piece out of a plurality of the second timing information pieces, compares the first timing information piece with the selected second timing information piece, identifies the second indicating hand position as the identified position in a case where a difference between the first timing information piece and the second timing information piece is equal to or more than the predetermined amount, or in a case where a plurality of the first timing information pieces are present, the control unit selects the first timing information piece closer to the second timing information piece out of a plurality of the first timing information pieces, compares the selected first timing information piece with the second timing information piece, and identifies the second indicating hand position as the identified position in a case where a difference between the first timing information piece and the second timing information piece is equal to or more than the predetermined amount.

5. The hand position identification device according to claim 1, wherein the timing information piece indicates what number-th is the induced voltage, with reference to a timing after the drive pulse is output.

6. The hand position identification device according to claim 1, wherein the timing information piece indicates an elapsed time until the induced voltage is generated, with reference to a timing after the drive pulse is output.

7. The hand position identification device according to claim 1, wherein in a case where the induced voltage exceeding the predetermined threshold is not detected by the rotation detection unit, the control unit increases drive energy of the drive pulse until the induced voltage is equal to or smaller than the predetermined threshold in a first region where the indicating hand is located at a reference position and until a load received by the rotor exceeds the induced voltage in a second region in which the load is lower than that of the first region.

8. The hand position identification device according to claim 1, wherein the rotation detection unit generates another predetermined threshold which is smaller than the predetermined threshold in a case where the induced voltage exceeding the predetermined threshold is not detected, and wherein the storage unit stores the timing information piece relating to a timing at which the induced voltage exceeds the another predetermined threshold.

9. The hand position identification device according to claim 1, wherein the rotation detection unit alternately switches a circuit including the coil into a high impedance state and a low impedance state which is lower than the high impedance state so as to detect the induced voltage in the low impedance state, and wherein in a case where the induced voltage exceeding the predetermined threshold is not detected, the rotation detection unit shortens a cycle for alternately switching the low impedance state and the high impedance state until the induced voltage exceeding the predetermined threshold is detected.

10. A timepiece comprising:
the hand position identification device according to claim 1.

11. A hand position identification method in a hand position identification device including a motor having a rotor and a coil, an indicating hand rotated by the motor, a rotation detection unit for detecting a rotation state of the rotor by using an induced voltage generated in the coil, and a storage unit, the method comprising:
a step of causing the rotation detection unit to detect the rotation state of the rotor by using the induced voltage generated in the coil after a drive pulse is output to the coil;
a step of causing a control unit to store a timing information piece relating to a timing at which the induced voltage exceeds a predetermined threshold, in a storage unit; and
a step of causing the control unit to compare a first timing information piece stored in the storage unit, which is a timing information piece obtained in a case where the indicating hand is located at a first indicating hand position, with a second timing information piece which is a timing information piece obtained in a case where the indicating hand is located at a second indicating hand position, and causing the control unit to identify the second indicating hand position as an identified position in a case where a difference between the first timing information piece and the second timing information piece is equal to or more than a predetermined amount.
